(19) United States
(12) Patent Application Publication
(10) Pub. No.: US 2020/0137529 A1
(43) Pub. Date: Apr. 30, 2020

(54) Multicast Data Sending Method and Apparatus, Device, and Storage Medium

(71) Applicant: Huawei Technologies Co., Ltd., Shenzhen (CN)

(72) Inventors: Jian Yu, Shenzhen (CN); Xiangbai Liao, Wuhan (CN); Yingzhuang Liu, Wuhan (CN)

(21) Appl. No.: 16/723,625

(22) Filed: Dec. 20, 2019

Related U.S. Application Data
(63) Continuation of application No. PCT/CN2018/092932, filed on Jun. 26, 2018.

(30) Foreign Application Priority Data
Jun. 26, 2017 (CN) 201710495188.5

(51) Int. Cl. H04W 4/06; H04L 1/04; H04W 52/02; H04L 27/26; H04L 1/06

(52) U.S. Cl. CPC H04W 4/06; H04L 1/04; H04W 84/12; H04L 27/2607; H04L 1/0643; H04W 52/0229

(57) ABSTRACT

A method includes obtaining multicast-broadcast single-frequency network MBSFN information, where the MBSFN information indicates a same first data sending manner, a same first channel, and a same first time point that are used when a plurality of forwarding devices send multicast data, where the multicast data is received from a control device; and forwarding the multicast data to at least one station device in the first data sending manner on the first channel at the first time point.

### CROSS-REFERENCE TO RELATED APPLICATIONS

This application is a continuation application of International Application No. PCT/CN2018/092932, filed on Jun. 26, 2018, which claims priority to Chinese Patent Application No. 201710495188.5, filed on Jun. 26, 2017. The disclosures of the aforementioned applications are hereby incorporated by reference in their entireties.

### TECHNICAL FIELD

This disclosure relates to the field of network technologies, and in particular, to a multicast data sending method and apparatus, a device, and a storage medium.

### BACKGROUND

A wireless local area network (WLAN) gradually becomes mature as network technologies develop. With advantages such as flexibility, convenience, and easy deployment, the WLAN brings great convenience to people's lives and can be widely applied to scenarios such as live webcasting, web conferencing, and web-based teaching. In these scenarios, same data needs to be sent from one sending direction to a plurality of receivers, and in this case, multicast data may be sent in a multicast manner.

A multicast data sending process involves interaction between a control device, a forwarding device, and a station device. The control device is connected to a plurality of forwarding devices, and each of the plurality of forwarding devices is connected to at least one station device. In the multicast data sending process, the control device sends multicast data to each forwarding device connected to the control device, each forwarding device receives the multicast data and sends the multicast data to at least one station device connected to the forwarding device, and the station device receives the multicast data.

The plurality of forwarding devices send the multicast data using a same channel. However, to avoid interference between different forwarding devices, only one forwarding device is allowed to occupy the channel at a time. Therefore, the plurality of forwarding devices need to contend for a channel. For each forwarding device, when needing to send multicast data, the forwarding device senses a channel to determine a status of the channel. When the channel is in a busy state, the forwarding device waits. When the channel is in an idle state, a random counter value is generated and is decreased over time. During this period, if another forwarding device occupies the channel, and consequently, the channel is switched to a busy state, the forwarding device suspends a decrease in the counter value. Subsequently, when the channel is switched back to an idle state, the forwarding device resumes decreasing the counter value from a previously suspended counter value, until the counter value is decreased to 0, which indicates that the forwarding device has obtained the channel through contention, and may send the multicast data on the channel in a self-determined data sending manner.

A related technology has at least the following problem.

Each forwarding device can send multicast data only after obtaining a channel through contention. The contention process usually takes a relatively long time, causing an excessively long time expended in sending the multicast data. For a plurality of forwarding devices, because the plurality of forwarding devices can only send multicast data on a channel in turn, efficiency in sending multicast data is relatively low.

### SUMMARY

Embodiments of this disclosure provide a multicast data sending method and apparatus, a device, and a storage medium, to resolve a problem in a related technology that efficiency in sending multicast data is excessively low due to channel contention. The technical solutions are as follows.

According to a first aspect, a multicast data sending method is provided, where the method includes obtaining multicast-broadcast single-frequency network (MBSFN) information, where the MBSFN information is used to indicate a same first data sending manner, a same first channel, and a same first time point that are used when a plurality of forwarding devices send multicast data, and the multicast data is received from a control device; and forwarding the multicast data to at least one station device in the first data sending manner on the first channel at the first time point.

In a first possible implementation of the first aspect, the MBSFN information is in an embodiment used to instruct the plurality of forwarding devices to send a wake-up data packet (WUP) to a station device and indicate a same second data sending manner, a same second channel, and a same second time point that are used to send the WUP; and after obtaining multicast-broadcast single-frequency network MBSFN information, the method in an embodiment includes sending the WUP to the at least one station device in the second data sending manner on the second channel at the second time point, and performing the step of sending the multicast data to at least one station device on the first channel at the first time point such that each of at least one station device receives the WUP using a configured wake-up radio (WUR) receiver, wakes up a main radio (MR) from a sleep state, making the MR into a working state, and receives the multicast data using the MR.

In a second possible implementation of the first aspect, the MBSFN information includes first channel information, first time information, and the first data sending manner, and the first data sending manner includes at least one of a physical layer packet format, a transmitter address (TA), a receiver address (RA), bandwidth, a guard interval (GI), a scrambler seed, a space-time block coding (STBC) identifier, and a dual carrier modulation (DCM) identifier; where the first channel information is used to indicate the first channel, the first time information is used to indicate the first time point, the physical layer packet format is used to indicate a same physical layer packet format used when the plurality of forwarding devices send the multicast data, the TA is used to indicate a same TA used when the plurality of forwarding devices send the multicast data, the RA is used to indicate a same RA used when the plurality of forwarding devices send the multicast data, the bandwidth is used to indicate same bandwidth used when the plurality of forwarding devices send the multicast data, the GI is used to indicate a same GI used when the plurality of forwarding devices send the multicast data, the scrambler seed is used to indicate a same scrambler seed used when the plurality of forwarding devices send the multicast data, the STBC identifier is used to indicate whether the plurality of forwarding devices send the multicast data in an STBC manner, and the DCM identifier is used to indicate whether the plurality of forwarding devices send the multicast data in a DCM manner.

In a third possible implementation of the first aspect, before the obtaining multicast-broadcast single-frequency network MBSFN information, the method in an embodiment includes receiving device information of a station device connected to the forwarding device, where the device information includes at least one of a supported WLAN protocol, an indication indicating whether STBC is supported, and an indication indicating whether DCM is supported, and the device information is used to indicate a data sending manner supported by the station device; and sending device statistical information to the control device, where the device statistical information is used to indicate at least one of the following such as whether a station device that supports each WLAN protocol exists in the station device connected to the forwarding device, whether a station device that does not support the STBC exists in the station device connected to the forwarding device, and whether a station device that does not support the DCM exists in the station device connected to the forwarding device; or the device statistical information is used to indicate at least one of a quantity of station devices that support each WLAN protocol in the station device connected to the forwarding device, a quantity of station devices that do not support the STBC in the station device connected to the forwarding device, and a quantity of station devices that do not support the DCM in the station device connected to the forwarding device such that the control device determines the MBSFN information based on the device statistical information sent by the plurality of forwarding devices, and returns the MBSFN information to the forwarding devices.

In a fourth possible implementation of the first aspect, obtaining multicast-broadcast single-frequency network MBSFN information includes parsing the multicast data to obtain the MBSFN information carried in the multicast data; or receiving a beacon frame sent by the control device, and parsing the beacon frame to obtain the MBSFN information carried in the beacon frame; or after device statistical information is sent to the control device, receiving the MBSFN information returned by the control device, where the MBSFN information is determined by the control device based on the device statistical information sent by the plurality of forwarding devices; or receiving connection information sent by the control device, and parsing the connection information to obtain the MBSFN information carried in the connection information, where the connection information is used to instruct the forwarding device to establish a connection to the control device; or obtaining prestored default MBSFN information.

In a fifth possible implementation of the first aspect, the MBSFN information includes first time information, where the first time information is used to indicate the first time point, and after obtaining multicast-broadcast single-frequency network MBSFN information, the method in an embodiment includes obtaining a specified time interval carried in the first time information, and using a time point at the end of the specified time interval starting from a time point at which the multicast data is received as the first time point; or obtaining a specified time interval carried in the first time information, receiving a synchronization frame sent by the control device, and using a time point at the end of the specified time interval starting from a time point at which the synchronization frame is received as the first time point; or obtaining the first time point carried in the first time information.

In a sixth possible implementation of the first aspect, after obtaining MBSFN information, the method in an embodiment includes performing the step of sending the multicast data to at least one station device in the first data sending manner on the first channel at the first time point when the first channel is in an idle state; and skipping sending the multicast data at the first time point when the first channel is in a busy state.

In a seventh possible implementation of the first aspect, the control device is an access point (AP), and the plurality of forwarding devices are a plurality of relays connected to the AP; or the control device is a specified AP in a plurality of APs, and the plurality of forwarding devices are a plurality of APs other than the specified AP in the plurality of APs; or the control device is an access controller (AC), and the plurality of forwarding devices are a plurality of APs connected to the AC.

According to a second aspect, a multicast data sending method is provided and applied to a control device, where the method includes determining MBSFN information, where the MBSFN information is used to indicate a same first data sending manner, a same first channel, and a same first time point that are used when a plurality of forwarding devices send multicast data; and sending the MBSFN information and the multicast data to the plurality of forwarding devices such that each of the plurality of forwarding devices sends the multicast data to at least one station device in the first data sending manner on the first channel at the first time point.

In a first possible implementation of the second aspect, the MBSFN information includes first channel information, first time information, and the first data sending manner, and the first data sending manner includes at least one of a physical layer packet format, a TA, a RA, bandwidth, a GI, a scrambler seed, a STBC identifier, and a DCM identifier; where the MBSFN information is, in an embodiment, used to instruct the plurality of forwarding devices to send a WUP to a station device and indicate a same second data sending manner, a same second channel, and a same second time point that are used to send the WUP, the first channel information is used to indicate the first channel, the first time information is used to indicate the first time point, the physical layer packet format is used to indicate a same physical layer packet format used when the plurality of forwarding devices send the multicast data, the TA is used to indicate a same TA used when the plurality of forwarding devices send the multicast data, the RA is used to indicate a same RA used when the plurality of forwarding devices send the multicast data, the bandwidth is used to indicate same bandwidth used when the plurality of forwarding devices send the multicast data, the GI is used to indicate a same GI used when the plurality of forwarding devices send the multicast data, the scrambler seed is used to indicate a same scrambler seed used when the plurality of forwarding devices send the multicast data, the STBC identifier is used to indicate whether the plurality of forwarding devices send the multicast data in an STBC manner, and the DCM identifier is used to indicate whether the plurality of forwarding devices send the multicast data in a DCM manner.

In a second possible implementation of the second aspect, before determining MBSFN information, the method in an embodiment includes receiving device statistical information sent by each of the plurality of forwarding devices, where the device statistical information is used to indicate at least one of the following such as whether a station device that supports each WLAN protocol exists in a station device connected to a related forwarding device, whether a station device that does not support the STBC exists in the station device connected to the related forwarding device, and whether a station device that does not support the DCM exists in the station device connected to the related forwarding device; or the device statistical information is used to indicate at least one of a quantity of station devices that support each WLAN protocol in the station device connected to the related forwarding device, a quantity of station devices that do not support the STBC in the station device connected to the related forwarding device, and a quantity of station devices that do not support the DCM in the station device connected to the related forwarding device; determining, based on the device statistical information sent by the plurality of forwarding devices, a data sending manner supported by the station devices connected to the plurality of forwarding devices; and determining the MBSFN information based on the data sending manner supported by all the station devices connected to the plurality of forwarding devices; or determining the MBSFN information based on a data sending manner supported by more than a specified quantity of station devices in the station devices connected to the plurality of forwarding devices.

In a third possible implementation of the second aspect, sending the MBSFN information and the multicast data to the plurality of forwarding devices includes adding the MBSFN information to the multicast data, and sending the multicast data that carries the MBSFN information to the plurality of forwarding devices; or adding the MBSFN information to a beacon frame, and sending the beacon frame and the multicast data to the plurality of forwarding devices; or adding the MBSFN information to connection information, and sending the connection information and the multicast data to the plurality of forwarding devices, where the connection information is used to instruct each of the plurality of forwarding devices to establish a connection to the control device.

In a fourth possible implementation of the second aspect, the control device is an AP, and the plurality of forwarding devices are a plurality of relays relays connected to the AP; or the control device is a specified AP in a plurality of APs, and the plurality of forwarding devices are a plurality of APs other than the specified AP in the plurality of APs; or the control device is an AC, and the plurality of forwarding devices are a plurality of APs connected to the AC.

According to a third aspect, a multicast data sending apparatus is provided, where the multicast data sending apparatus is configured to perform the method provided in the first aspect.

According to a fourth aspect, a multicast data sending apparatus is provided, where the multicast data sending apparatus is configured to perform the method provided in the second aspect.

According to a fifth aspect, a forwarding device is provided, where the forwarding device includes a processor and a memory, the memory stores at least one instruction, and the instruction is loaded and executed by the processor to implement the method provided in the first aspect.

According to a sixth aspect, a control device is provided, where the control device includes a processor and a memory, the memory stores at least one instruction, and the instruction is loaded and executed by the processor to implement the method provided in the second aspect.

According to a seventh aspect, a computer-readable storage medium is provided, where the storage medium stores at least one instruction, and the instruction is loaded and executed by a processor to implement the method provided in the first aspect.

According to an eighth aspect, a computer-readable storage medium is provided, where the storage medium stores at least one instruction, and the instruction is loaded and executed by a processor to implement the method provided in the second aspect.

According to a ninth aspect, a computer program product including an instruction is provided, and when the computer program product runs on a forwarding device, the forwarding device is enabled to implement the method provided in the first aspect.

According to a tenth aspect, a computer program product including an instruction is provided, and when the computer program product runs on a control device, the control device is enabled to implement the method provided in the second aspect.

Beneficial effects brought by the technical solutions provided in the embodiments of this disclosure include at least the following.

According to the method, apparatus, and device, and storage medium provided in the embodiments of this disclosure, a plurality of forwarding devices obtain same MBSFN information, and can send multicast data in a same data sending manner on a same channel at a same time point based on the same MBSFN information. In this way, no interference is caused between different forwarding devices. In addition, the forwarding devices each do not need to contend for a channel. This shortens a time expended in sending multicast data and improves efficiency in sending multicast data. For a plurality of forwarding devices, because the plurality of forwarding devices send data on a channel at the same time rather than send the data in turn, efficiency in sending multicast data is also improved.

In an embodiment, the plurality of forwarding devices may sense a channel to determine a status of the channel. When the channel is in an idle state, the multicast data is sent at a same time point; when the channel is in a busy state, the multicast data is not sent at a same time point. This avoids interference caused by another data on the channel to a multicast data transmission process, and prevents signal collision between cells.

In an embodiment, considering that data sending manners supported by different station devices may be different, a data sending manner supported by all station devices is used as a data sending manner to send multicast data, or a data sending manner supported by more than a specified quantity of station devices is used as a data sending manner to send multicast data, to ensure that as many station devices as possible successfully receive the multicast data as possible, and improve efficiency in sending multicast data.

In an embodiment, a plurality of forwarding devices send a WUP in a same data sending manner on a same channel at a same time point. In this way, no interference is caused between different forwarding devices. In addition, the forwarding devices each do not need to contend for a channel. This reduces a time expended in sending a WUP, and improves efficiency in sending a WUP. For a plurality of forwarding devices, because the plurality of forwarding devices send a WUP on a channel at the same time rather than send the WUP in turn, efficiency in sending a WUP is also improved.

### BRIEF DESCRIPTION OF DRAWINGS

FIG. 1 is a schematic structural diagram of a data communications system according to an embodiment of this disclosure;

FIG. 2 is a schematic structural diagram of a data communications system according to an embodiment of this disclosure;

FIG. 3 is a schematic structural diagram of a data communications system according to an embodiment of this disclosure;

FIG. 4 is a schematic structural diagram of a data communications system according to an embodiment of this disclosure;

FIG. 5 is a flowchart of a multicast data sending method according to an embodiment of this disclosure;

FIG. 6 is a schematic diagram of a multicast data transmission process according to an embodiment of this disclosure;

FIG. 7 is a schematic diagram of a multicast data transmission process according to an embodiment of this disclosure;

FIG. 8 is a schematic diagram of a multicast data transmission process according to an embodiment of this disclosure;

FIG. 9 is a schematic diagram of a multicast data transmission process according to an embodiment of this disclosure;

FIG. 10A and FIG. 10B are a flowchart of a multicast data sending method according to an embodiment of this disclosure;

FIG. 11 is a schematic diagram of a multicast data transmission process according to an embodiment of this disclosure;

FIG. 12 is a schematic diagram of a multicast data transmission process according to an embodiment of this disclosure;

FIG. 13 is a schematic structural diagram of a multicast data sending apparatus according to an embodiment of this disclosure;

FIG. 14 is a schematic structural diagram of a multicast data sending apparatus according to an embodiment of this disclosure;

FIG. 15 is a schematic structural diagram of a forwarding device according to an embodiment of this disclosure; and

FIG. 16 is a schematic structural diagram of a control device according to an embodiment of this disclosure.

### DESCRIPTION OF EMBODIMENTS

To make the objectives, technical solutions, and advantages of this disclosure clearer, the following embodiments describe the implementations of this disclosure in detail with reference to the accompanying drawings.

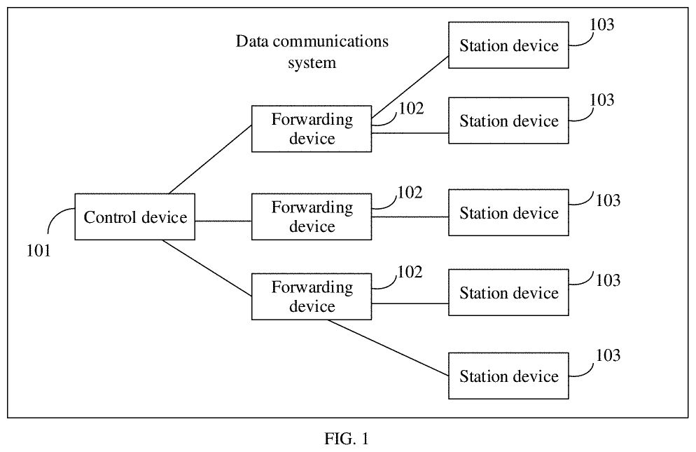

FIG. 1 is a schematic structural diagram of a data communications system. The data communications system includes a control device 101, a plurality of forwarding devices 102, and a plurality of station devices 103. The control device 101 is connected to the plurality of forwarding devices 102, and each forwarding device 102 is connected to at least one station device 103.

The control device 101 is configured to send same multicast data to the plurality of forwarding devices 102, each of the plurality of forwarding devices 102 is configured to receive the multicast data and send the multicast data to the at least one station device 103 in a same data sending manner on a same channel at a same time point, and each of the at least one station device 103 is configured to receive the multicast data. The multicast data may be voice data, video data, text data, or the like.

In the embodiments of this disclosure, the station device 103 may be a mobile phone, a computer, a tablet computer, or the like, and the control device and the forwarding device may be devices of different types in different scenarios.

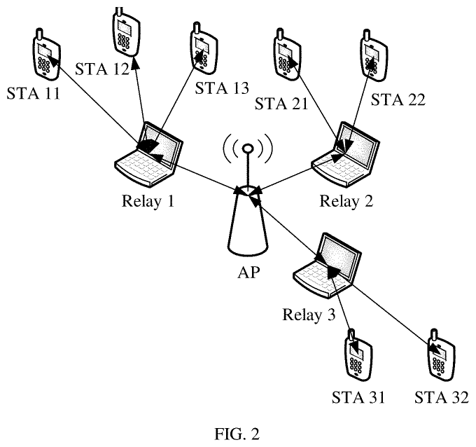

In an exemplary scenario, referring to FIG. 2, the control device 101 is an access point (AP), the forwarding device 102 is a relay connected to the AP, for example, a relay 1, a relay 2, or a relay 3, and the station device 103 is a station (STA) connected to the relay, for example, the station device connected to the relay 1 is a STA 11, a STA 12, or a STA 13. The AP may be a router, a gateway, a bridge, a base station, or the like, and the relay may be a repeater, a terminal, or the like.

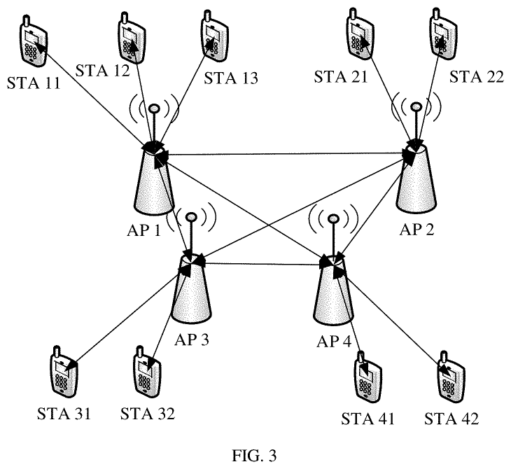

In another exemplary scenario, referring to FIG. 3, the control device 101 is a specified AP in a plurality of APs, for example, an AP 1. The forwarding devices 102 are a plurality of APs, for example, an AP 1, an AP 2, an AP 3, and an AP 4, and the station device 103 is a STA connected to the AP, for example, the station device connected to the AP 1 is a STA 11, a STA 12, or a STA 13. The specified AP may be a master AP in the plurality of APs, and other APs are slave APs of the master AP. The master AP may be determined by the plurality of APs through negotiation, or be specified by an access controller (Access Controller, AC). Alternatively, the specified AP is any AP in the plurality of APs.

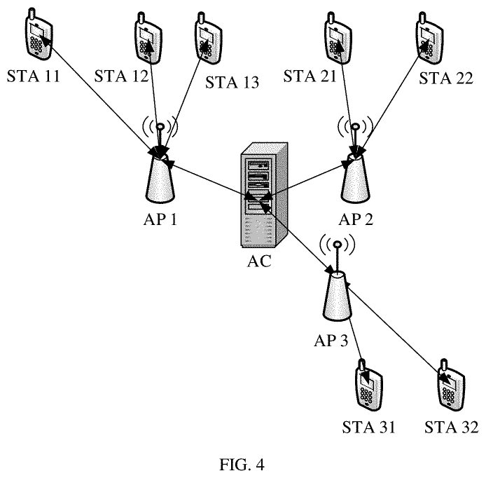

In another exemplary scenario, referring to FIG. 4, the control device 101 is an AC, the AC may be a switch, a gateway, a server, or the like, the forwarding device 102 is an AP connected to the AC, for example, an AP 1, an AP 2, or an AP 3, and the station device 103 is a STA connected to the AP, for example, a station device connected to the AP 1 is a STA 11, a STA 12, or a STA 13.

The data communications system provided in the embodiments of this disclosure is applied to a WLAN, and supports protocols of 802.11 series, including but not limited to an 802.11 protocol, an 802.11a protocol, an 802.11b protocol, an 802.11g protocol, an 802.11n protocol, an 802.11ac protocol, an 802.11 lax, an 802.11ad, an 802.11ay, an 802.11ah protocol, and the like. In the data communications system, same data can be sent from one sending direction to a plurality of receivers, and various application scenarios such as live webcasting, web conferencing, and web-based teaching are supported. For example, in a place such as a conference room, a classroom, or a stadium, a speaker or an activity host can send a video or another data to a plurality of listeners using the data communications system.

In a related technology, for a process of sending multicast data by a plurality of forwarding devices, only one forwarding device is allowed to occupy a channel at a time. Each forwarding device contends for a channel according to a carrier sense multiple access with collision avoidance (CSMA/CA) protocol and sends multicast data on the channel in turn.

However, in the data communications system provided in the embodiments of this disclosure, a plurality of forwarding devices can send multicast data in a same data sending manner on a same channel at a same time point. Because of a same time point and same data sending manner of sending the multicast data, no interference is caused between different forwarding devices. In addition, because the plurality of forwarding devices send data on a channel at the same time rather than send the data in turn, efficiency in sending the multicast data is improved.

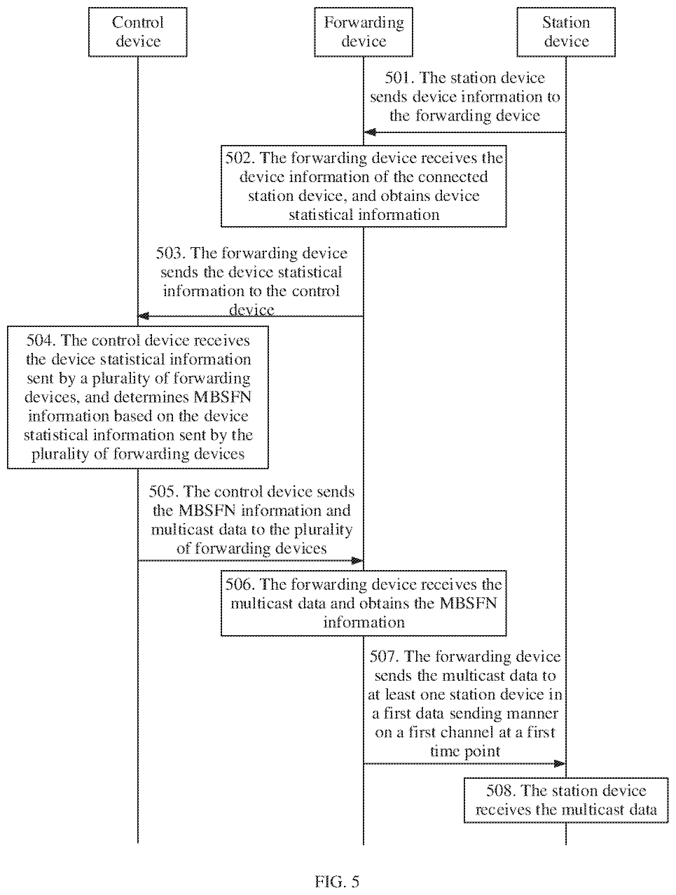

FIG. 5 is a flowchart of a multicast data sending method according to an exemplary embodiment. The method may be applied to the foregoing data communications system, with interaction bodies including a control device, a forwarding device, and a forwarding device, and the method includes the following steps.

501. A station device sends device information to the forwarding device.

The device information is used to indicate a data sending manner supported by the station device, including at least one of a supported WLAN protocol, an indication indicating whether STBC is supported, and an indication indicating about whether DCM is supported, as shown in Table 1.

TABLE 1

| | Indication indicating | Indication indicating |
|---|---|---|
| Supported WLAN | whether STBC | whether DCM |
| protocol | is supported | is supported |
| 802.11ax protocol | 1 | 1 |

For the WLAN protocol, the device information includes a field corresponding to the WLAN protocol, and the field is used to carry an identifier of a supported WLAN protocol, for example, a name or a serial number of the WLAN protocol. The WLAN protocol may be an 802.11g protocol, an 802.11n protocol, an 802.11ac protocol, or an 802.11ax protocol. Because the station device has backward compatibility, that is, if the station device supports a WLAN protocol, the station device in an embodiment supports another WLAN protocol released earlier than the WLAN protocol. To reduce an amount of data of the device information, the field corresponding to the WLAN protocol may carry only an identifier of a WLAN protocol that is latest released in all WLAN protocols supported by the station device, to indicate that the station device supports the WLAN protocol carried in the field and another WLAN protocol released earlier than the WLAN protocol carried in the field.

For the STBC, the STBC means that to-be-sent data is separately encoded in two dimensions of a space domain and a time domain, and the indication indicating whether the STBC is supported is used to indicate whether the station device supports the STBC. The device information may include a field corresponding to the indication indicating whether the STBC is supported. In the field, a first identifier is used to indicate that the station device supports the STBC, and receives data sent in an STBC manner, while a second identifier is used to indicate that the station device does not support the STBC, and does not receive data sent in the STBC manner. The first identifier and the second identifier are different identifiers corresponding to each other. For example, the first identifier is 1, and the second identifier is 0; or the first identifier is Y, and the second identifier is N.

For the DCM, the DCM means dividing data into two parts and modulating two carrier signals separately. The indication indicating whether the DCM is supported is used to indicate whether the station device supports the DCM. The device information may include a field corresponding to the indication indicating whether the DCM is supported. In the field, a first identifier is used to indicate that the station device supports the DCM, and receives data sent in a DCM manner, while a second identifier is used to indicate that the station device does not support the DCM, and does not receive data sent in the DCM manner.

502. The forwarding device receives the device information of the connected station device, and obtains device statistical information.

In a possible implementation, the device statistical information may be used to indicate whether a station device that supports a specific data sending manner exists in a station device connected to the forwarding device, or used to indicate whether a station device that does not support a specific data sending manner exists in the station device connected to the forwarding device.

When the data sending manner of the station device includes at least one of the supported WLAN protocol, the indication indicating whether the STBC is supported, and the indication indicating whether the DCM is supported, correspondingly, the device statistical information is used to indicate at least one of the following such as whether a station device that supports each WLAN protocol exists in the station device connected to the forwarding device, whether a station device that does not support the STBC exists in the station device connected to the forwarding device, and whether a station device that does not support the DCM exists in the station device connected to the forwarding device.

For the WLAN protocol, the device statistical information includes at least one field corresponding to at least one WLAN protocol. In a first case, in each field, a first identifier is used to indicate that a station device that supports a corresponding WLAN protocol exists, and a second identifier is used to indicate that a station device that supports the corresponding WLAN protocol does not exist. Therefore, for a field corresponding to a specific WLAN protocol, when at least one station device in the station device connected to the forwarding device supports the WLAN protocol, the forwarding device adds a first identifier to the field, or when none of the station device connected to the forwarding device supports the WLAN protocol, the forwarding device adds a second identifier to the field. For example, if the forwarding device is connected to 100 station devices, provided that one station device in the 100 station devices supports the 802.11 ax protocol, 1 is added to a field corresponding to the 802.11 ax protocol. If none of the 100 station devices supports the 802.1 lax protocol, 0 is added to the field corresponding to the 802.11 ax protocol.

The device statistical information may be shown in the following Table 2, and includes four fields respectively corresponding to the four WLAN protocols such as the 802.11g protocol, the 802.11n protocol, the 802.11 ac protocol, and the 802.11 ax protocol. A “1g STA present” field is the field corresponding to the 802.11g protocol, and an identifier 0 in the field indicates that a station device that supports the 802.11g protocol does not exist. A “11n STA present” field is the field corresponding to the 802.11n protocol, and an identifier 1 in the field indicates that a station device that supports the 802.11n protocol exists.

TABLE 2

| 11g STA | 11n STA | 11ac STA | 11ax STA |
|---|---|---|---|
| present | present | present | present |
| 1 | 1 | 1 | 0 |

In a second case, in each field, a first identifier is used to indicate that a station device that supports a latest released WLAN protocol exists in the station device connected to the forwarding device, where the latest released WLAN protocol is a related WLAN protocol; and the second identifier is used to indicate that a station device that supports the latest released WLAN protocol does not exist in the station device connected to the forwarding device, and the latest released WLAN protocol is the related WLAN protocol. Therefore, for a field corresponding to a specific WLAN protocol, when a station device that supports a latest released WLAN protocol exists in the station device connected to the forwarding device, and the latest released WLAN protocol is the related WLAN protocol, the forwarding device adds a first identifier to the field, while when none of the latest released WLAN protocols supported by the station device connected to the forwarding device is the WLAN protocol, the forwarding device adds a second identifier to the field. For example, if the forwarding device is connected to 100 station devices, provided that one station device in the 100 station devices supports a latest released WLAN protocol, and the latest released WLAN protocol is the 802.11 lax protocol, 1 is added to a field corresponding to the 802.11ax protocol. If none of the latest released WLAN protocols supported by the 100 station devices is the 802.11ax protocol, 0 is added to the field corresponding to the 802.11 ax protocol.

In an embodiment, in the device information of the station device, the field corresponding to the WLAN protocol may carry only an identifier of a WLAN protocol that is latest released in the WLAN protocols supported by the station device, and does not carry an identifier of another WLAN protocol. Therefore, for a field corresponding to a WLAN protocol, it can be determined, based on whether an identifier of a related WLAN protocol is included in the device information of the station device, whether the station device that supports the latest released WLAN protocol exists in the station devices, where the latest released WLAN protocol is a related WLAN protocol. In other words, when the device information of the station device connected to the forwarding device includes the identifier of the related WLAN protocol, the forwarding device adds the first identifier to the field; and when the device information of the station device connected to the forwarding device does not include the identifier of the related WLAN protocol, the forwarding device adds the second identifier to the field.

The device statistical information may be shown in the following Table 3, and includes four fields respectively corresponding to the four WLAN protocols such as the 802.11g protocol, the 802.11n protocol, the 802.11 ac protocol, and the 802.11 ax protocol. The “1 g STA present” field is the field corresponding to the 802.11g protocol, and the identifier 0 in the field indicates that a station device that supports a latest released WLAN protocol does not exist, where the WLAN protocol is the 802.11g protocol, does not exist; or the identifier 0 indicates that none of the WLAN protocols supported by the station device is the 802.11g protocol.

TABLE 3

| 11g STA | 11n STA | 11ac STA | 11ax STA |
|---|---|---|---|
| present | present | present | present |
| 0 | 0 | 1 | 1 |

For the STBC, the device statistical information includes a field corresponding to the STBC. In the field, a first identifier is used to indicate that a station device that supports the STBC exists, and a second identifier is used to indicate that a station device that supports the STBC does not exist. Therefore, when at least one station device in the station device connected to the forwarding device does not support the STBC, the forwarding device adds a first identifier to the field, while when all of the station device connected to the forwarding device support the STBC, the forwarding device adds a second identifier to the field. For example, if the forwarding device is connected to 100 station devices, provided that one station device in the 100 station devices does not support the STBC, 1 is added to the field corresponding to the STBC. If all of the 100 station devices support the STBC, 0 is added to the field corresponding to STBC.

For example, the device statistical information may be shown in the following Table 4. “STBC incapable STA present” is the field corresponding to STBC, and an identifier 0 in the field indicates that at least one station device supports the STBC.

TABLE 4
STBC incapable STA present
0

For the DCM, the device statistical information includes a field corresponding to the DCM. In the field, a first identifier is used to indicate that a station device that supports the DCM exists, and a second identifier used to indicate that a station device that supports the DCM does not exist. Therefore, when at least one station device in the station device connected to the forwarding device does not support the DCM, the forwarding device adds a first identifier to the field, while when all of the station device connected to the forwarding device support the DCM, the forwarding device adds a second identifier to the field. For example, if the forwarding device is connected to 100 station devices, provided that one station device in the 100 station devices does not support the DCM, 1 is added to the field corresponding to the DCM. If all of the 100 station devices support the DCM, 0 is added to the field corresponding to DCM.

For example, the device statistical information may be shown in the following Table 5. “DCM STBC incapable STA present” is the field corresponding to DCM, and an identifier 0 in the field indicates that at least one station device supports the DCM.

TABLE 5
DCM incapable STA present
0

In a possible implementation, the device statistical information may be used to indicate a quantity of station devices that support a specific data sending manner in the station device connected to the forwarding device, or used to indicate a quantity of station devices that do not support a specific data sending manner in the station device connected to the forwarding device.

When the data sending manner of the station device includes at least one of the supported WLAN protocol, the indication indicating whether the STBC is supported, and the indication indicating whether the DCM is supported, correspondingly, the device statistical information is used to indicate at least one of a quantity of station devices that support each WLAN protocol in the station device connected to the forwarding device, a quantity of station devices that do not support the STBC in the station device connected to the forwarding device, and a quantity of station devices that do not support the DCM in the station device connected to the forwarding device.

For the WLAN protocol, the device statistical information includes at least one field corresponding to at least one WLAN protocol. In the first case, a value carried in each field represents a quantity of station devices that support a related WLAN protocol. Therefore, for a field corresponding to a specific WLAN protocol, the forwarding device counts a quantity of station devices that support the WLAN protocol in the station devices, and adds the quantity of the station devices to the field.

For example, the device statistical information may be shown in the following Table 6, and includes four fields respectively corresponding to the four WLAN protocols such as the 802.11g protocol, the 802.11n protocol, the 802.11ac protocol, and the 802.11ax protocol. A “11 g STA number” field is the field corresponding to the 802.11g protocol, and a value carried in the field is 300, indicating that 300 station devices support the 802.11g protocol.

TABLE 6

| 11g STA | 11n STA | 11ac STA | 11ax STA |
|---|---|---|---|
| number | number | number | number |
| 300 | 200 | 100 | 30 |

In the second case, a value carried in each field represents a quantity of the station devices that support the latest released WLAN protocol in the station devices, where the latest released WLAN protocol is a related WLAN protocol. Therefore, for a field corresponding to a specific WLAN protocol, the forwarding device counts the quantity of the station devices that support the latest released WLAN protocol in the station devices, where the latest released WLAN protocol is the WLAN protocol, and adds the quantity of the station devices to the field.

In an embodiment, in the device information of the station device, a field corresponding to the WLAN protocol can carry only an identifier of a WLAN protocol that is latest released in the WLAN protocols supported by the station device, and does not carry an identifier of another WLAN protocol. Therefore, for a field corresponding to a specific WLAN protocol, during counting the quantity of the station devices that support the latest released WLAN protocol in the station devices, where the latest released WLAN protocol is the related WLAN protocol, a quantity of station devices whose device information includes the identifier of the related WLAN protocol may be used as the quantity of station devices, and the quantity of pieces of device information is added to the field.

For example, the device statistical information may be shown in the following Table 7, and includes four fields respectively corresponding to the four WLAN protocols such as the 802.11g protocol, the 802.11n protocol, the 802.11 ac protocol, and the 802.11 ax protocol. The “11g STA number” field is the field corresponding to the 802.11g protocol, and a value carried in the field is 10, indicating that the latest released WLAN protocol supported by 10 station devices is the 802.11g protocol.

TABLE 7

| 11g STA | 11n STA | 11ac STA | 11ax STA |
|---|---|---|---|
| number | number | number | number |
| 10 | 20 | 100 | 30 |

For the STBC, the device statistical information includes a field corresponding to the STBC, and a value carried in the field represents a quantity of station devices that do not support the STBC. Therefore, the forwarding device counts, based on the device information of the station device connected to the forwarding device, a quantity of station devices that do not support the STBC in the station devices, and adds the quantity of station devices to the field.

For example, the device statistical information may include information shown in the following Table 8. An “STBC incapable STA number” is the field corresponding to STBC, and a value 5 carried in the field indicates that five station devices do not support the STBC.

TABLE 8
STBC incapable STA number
5

For the DCM, the device statistical information includes a field corresponding to the DCM, and a value carried in the field represents a quantity of station devices that do not support the DCM. Therefore, the forwarding device counts, based on the device information of the station device connected to the forwarding device, a quantity of station devices that do not support the DCM in the station devices, and adds the quantity of station devices to the field.

For example, the device statistical information may include information shown in the following Table 9. A “DCM incapable STA number” is the field corresponding to DCM, and a value 5 carried in the field indicates that five station devices do not support the DCM.

TABLE 9
DCM incapable STA number
5

503. The forwarding device sends the device statistical information to the control device.

This step may specifically include 5031 or 5032.

5031. The forwarding device adds the device statistical information to an information element of a media access control (MAC) layer frame, and sends the MAC frame to the control device.

The MAC frame includes a frame header and a frame body (body). The frame body includes the information element used to carry information, where the information element includes an element identifier, a length of an element identifier, and carried information. The element identifier (Element ID) is used to indicate a type of the information carried in the information element. A first element identifier indicates that the information element carries the device statistical information, and a second element identifier indicates that the information element carries MBSFN information. For example, when the device statistical information is added to the information element of the MAC frame by the forwarding device, the information element may be shown in the following Table 10.

TABLE 10

| | | | | | STBC | DCM | |
|---|---|---|---|---|---|---|---|
| | | 11g STA | 11n STA | 11ac STA | incapable | incapable | |
| Element identifier | Length | present | present | present | STA present | STA present | . . . |
| First element identifier | 1 | 0 | 0 | 1 | 1 | 0 | . . . |

5032. The forwarding device adds the device statistical information to the frame header of the MAC frame, and sends the MAC frame to the control device.

The frame header of the MAC frame includes a plurality of control fields, for example, an aggregated control (A-control) field located in a high throughput control (HT Control) field. The control field includes a control identifier and carried information. The control identifier (Control ID) is used to indicate a type of the information carried in the control field. The forwarding device and the control device may agree on the following. The first control identifier indicates that the control field carries the device statistical information, and the second control identifier indicates that the control field carries the MBSFN information. For example, when the device statistical information is added to the control field of the MAC frame by the forwarding device, the control field may be shown in the following Table 11.

TABLE 11

| | | | | STBC | DCM | |
|---|---|---|---|---|---|---|
| | 11g STA | 11n STA | 11ac STA | incapable | incapable | |
| Control identifier | present | present | present | STA present | STA present | . . . |
| First control identifier | 0 | 0 | 1 | 1 | 0 | . . . |

504. The control device receives the device statistical information sent by a plurality of forwarding devices, and determines the MBSFN information based on the device statistical information sent by the plurality of forwarding devices.

To enable the plurality of forwarding devices to send multicast data in a unified data sending manner on a unified channel at a unified time point in a subsequent process, the control device determines the MBSFN information, where the MBSFN information is used to indicate a same first data sending manner, a same first channel, and a same first time point that are used when the plurality of forwarding devices send the multicast data. A process of determining the MBSFN information includes the following steps S041 to S043.

5041. Determine the first channel.

The control device may obtain a plurality of preconfigured channels, select a channel from the plurality of preconfigured channels as the first channel, and indicate the first channel using the MBSFN information, where the first channel may refer to a frequency band, a subcarrier, or the like.

5042. Determine the first time point.

The control device may select any time point after a time point at which the multicast data is sent to the station device as the first time point, and indicate the first time point using the MBSFN information.

5043. Determine the first data sending manner, which may include the following two manners.

Manner 1: Determine a data sending manner supported by any station device connected to the plurality of forwarding devices, and use the data sending manner as the first data sending manner.

Manner 2: Determine a data sending manner supported by more than a specified quantity of station devices in the station devices connected to the plurality of forwarding devices, and use the data sending manner as the first data sending manner.

The data sending manner includes at least one of a physical layer packet format, a TA, aRA, bandwidth, aG), a scrambler seed (Scramble seed), whether to use an STBC manner, or whether to use a DCM manner. The control device determines specific content of the at least one data sending manner, and the first data sending manner that needs to be used when the forwarding device sends the multicast data can be obtained.

(1) Physical layer packet format.

Referring to the following Table 12, each WLAN protocol includes a supported physical layer packet format. The 802.11g protocol supports a non-high throughput format or a non-high throughput duplicate (Non-High Throughput or Non-HT Duplicate, Non-HT) format, the 802.11n protocol supports a high throughput (High Throughput, HT) format, the 802.11ac protocol supports a very high throughput (Very High Throughput, VHT) format, and the 802.11 ax protocol supports a high efficiency (High Efficient, HE) format and classifies the HE format into a single-user format, a multi-user format, a trigger frame-based format, and an extended distance format.

TABLE 12

| Released | | Physical |
|---|---|---|
| time | WLAN protocol | packet format |
| Early | 802.11g protocol | Non-HT format |
| | 802.11n protocol | HT format |
| Latest | 802.11ac protocol | VHT format |
| | 802.11ax protocol | HE format |

In consideration of the backward compatibility of the station device, a correspondence between the station device and the supported physical layer packet format may be shown in Table 13.

TABLE 13

| Station | Supported physical |
|---|---|
| device | layer packet format |
| 802.11g site | Non-HT format |
| 802.11n site | Non-HT format, |
| | and the HT format |
| 802.11ac site | Non-HT format, the HT format, |
| | and the VHT format |
| 802.11ax site | Non-HT format, the HT format, |
| | the VHT format, and |
| | the HE format |

In this embodiment, first, both a new station device and an old station device exist, and the old station device may not support a physical layer packet format indicated by a WLAN protocol released relatively late. From an overall perspective, it needs to be ensured that a majority of station devices can support a selected physical layer packet format. Second, stronger robustness of the selected physical layer packet format indicates a stronger anti-interference capability in a multicast data transmission process. To avoid interference caused when a plurality of forwarding devices transmit multicast data on a same channel, a physical layer packet format of relatively strong robust needs to be selected. A physical layer packet format in a later released WLAN protocol is usually of stronger robustness. Therefore, a physical layer packet format in the WLAN protocol released relatively late may be selected as much as possible, for example, the HE format or the extended distance format in the HE format is selected.

In view of this, the control device may determine, based on the device statistical information sent by the plurality of forwarding devices, the WLAN protocol supported by the station device, and in an embodiment determine the physical layer packet format supported by the station device. For the foregoing manner 1, a physical layer packet format supported by all the station devices is selected from a plurality of physical layer packet formats, and a physical layer packet format of strongest robustness is in an embodiment selected from the selected result. For the foregoing manner 2, a physical layer packet format supported by more than a specified quantity of station devices is selected from the plurality of physical layer packet formats, and a physical layer packet format of strongest robustness is in an embodiment selected from the selected result.

It should be noted that, for manner 2, a physical layer packet format determined by the control device may not be supported by some station devices. Consequently, when the forwarding device subsequently sends multicast data to these station devices using the physical layer packet format, these station devices cannot successfully receive the multicast data. In this case, after sending the multicast data, the forwarding device separately sends the multicast data to these station devices using a physical layer packet format supported by these station devices.

(2) TA and RA.

The TA is used to indicate an address of a sender from which the multicast data is sent. In this embodiment, because the control device is a sending source of the multicast data, an address of the control device may be used as the TA. The address of the control device may be a MAC address of the control device, a basic service set (BSS) identifier (BSS ID) of a cell covered by the control device, a source address (SA) of a cell covered by the control device, or the like.

The RA is used to indicate an address of a receiver to which the multicast data is sent. In this embodiment, because the plurality of forwarding devices transmit the multicast data to the station device in a broadcast manner in a subsequent process, the multicast data is actually transmitted to a broadcast MAC address. In other words, the RA is the broadcast MAC address.

(3) Bandwidth

The bandwidth is channel bandwidth occupied when multicast data is sent on a channel. The control device may determine bandwidth based on a size of the multicast data and a requirement for a transmission rate. For example, if the multicast data is relatively large, a relatively large bandwidth is used, or if the multicast data needs to be transmitted at a relatively fast speed, a relatively large bandwidth is used.

(4) Scrambler Seed.

The scrambler seed is used for a scrambling process and a descrambling process. Specifically, to ensure secure data transmission, the sender scrambles raw data using the scrambler seed, and sends scrambled data. Correspondingly, the receiver descrambles the scrambled data using the scrambler seed, to obtain the raw data. In this embodiment, the control device may prestore a plurality of scrambler seeds, and select any scrambler seed from the plurality of scrambler seeds.

(5) GI.

The GI is a time interval between a time of sending a data block and a time of sending an adjacent data block, and may be 3.2 micro seconds (μs), 0.8 μs, 0.4 μs, or the like. Specifically, data is divided into a plurality of data blocks for transmission in space. Due to influence of a multipath environment, a front end of a next data block may reach ealier than a tail end of a current data block, causing interference between the two data blocks, namely, intercode interference. To avoid intercode interference as much as possible, the sender inserts an empty time interval after a sent data block, and sends a next data block after the time interval, where the time interval is a GI. In this embodiment, to ensure robustness of data transmission and in an embodiment avoid intercode interference, the control device may select a relatively large GI, for example, select a GI of 3.2 μs.

(6) Whether to Use an STBC Manner

The control device may determine, based on a plurality of pieces of device statistical information, whether the station device supports the STBC. For the foregoing manner 1, when all the station devices support the STBC, the control device determines to use an STBC manner. When at least one station device in the station devices does not support the STBC, the control device determines not to use the STBC manner. Alternatively, for the foregoing manner 2, when a quantity of station devices that support the STBC in the station devices exceeds a specified quantity, the control device determines to use the STBC manner; while when a quantity of station devices that support the STBC in the station devices does not exceed the specified quantity, the control device determines not to use the STBC manner.

It should be noted that, for the manner 2, if the control device determines to use the STBC manner, a case that some station devices may not support the STBC may occur. Consequently, when the forwarding device subsequently sends multicast data to these station devices using the STBC, these station devices cannot successfully receive the multicast data. In this case, after sending the multicast data, the forwarding device separately sends the multicast data to these station devices in a data sending manner in which the STBC is not used.

(7) Whether to Use a DCM Manner.

The control device may determine, based on a plurality of pieces of device statistical information, whether the station device supports the DCM. For the foregoing manner 1, when all the station devices support the DCM, the control device determines to use a DCM manner. When at least one station device in the station devices does not support the DCM, the control device determines not to use the DCM manner. Alternatively, for the foregoing manner 2, when a quantity of station devices that support the DCM in the station devices exceeds a specified quantity, the control device determines to use the DCM manner; while when a quantity of station devices that support the DCM in the station device does not exceed the specified quantity, the control device determines not to use the DCM manner.

It should be noted that, for the manner 2, if the control device determines to use the DCM manner, a case that some station devices may not support the DCM may occur. Consequently, when the forwarding device subsequently sends multicast data to these station devices using the DCM, these station devices cannot successfully receive the multicast data. In this case, after sending the multicast data, the forwarding device separately sends the multicast data to these station devices in a data sending manner in which the DCM is not used.

After determining the first channel, the first time point, and the first data sending manner, the control device may generate the MBSFN information, where the MBSFN information includes at least one of first channel information, first time information, and the first data sending manner, and the first data sending manner includes at least one of a physical layer packet format, a TA, an RA, bandwidth, a GI, a scrambler seed, an STBC identifier, or a DCM identifier.

The first channel information is used to indicate the first channel, and may be a name, a number, or the like of the first channel, and may be carried in a field in the MBSFN information.

The first time information may carry a specified time interval, and that a time point at the end of the specified time interval starting from a time point at which the forwarding device receives the multicast data is the first time point. Alternatively, the first time information may carry a specified time interval, and that a time point at the end of the specified time interval starting from a time point at which the forwarding device receives a synchronization frame is the first time point. Alternatively, the first time information may carry the first time point. The first time information may be carried in a field in the MBSFN information, for example, carried in a “Tx time” field.

The STBC identifier may be carried in a field in the MBSFN information, a first identifier is used to indicate that the forwarding device sends the multicast data in an STBC manner, and a second identifier is used to indicate that the forwarding device does not send the data in an STBC manner. Therefore, when the control device determines to use the STBC manner, the STBC identifier in the generated MBSFN information is the first identifier, and when the control device determines not to use the STBC manner, the STBC identifier in the generated MBSFN information is the second identifier.

The DCM identifier may be carried in a field in the MBSFN information, the first identifier is used to indicate that the forwarding device sends the multicast data in the DCM manner, and the second identifier is used to indicate that the forwarding device does not send the data in the DCM manner. Therefore, when the control device determines to use the DCM manner, the DCM identifier in the generated MBSFN information is the first identifier, and when the control device determines not to use the DCM manner, the DCM identifier in the generated MBSFN information is the second identifier.

505. The control device sends the MBSFN information and the multicast data to the plurality of forwarding devices.

For different manners of sending the MBSFN information and the multicast data, the step may include the following steps S051 to S053.

5051. The control device adds the MBSFN information to the multicast data, and sends the multicast data that carries the MBSFN information to the plurality of forwarding devices.

The multicast data may be the MAC frame. The control device may add the MBSFN information in an information element of the MAC frame. The information element may be shown in the following Table 14. Alternatively, the control device may add the MBSFN information to a control field of the frame header of the MAC frame, the control field may be shown in the following Table 15.

TABLE 14

| | | Physical | | | | | | | | | |
|---|---|---|---|---|---|---|---|---|---|---|---|
| | | layer | | | | | | | First | First | |
| Element | | packet | Scrambler | STBC | DCM | | | | time | channel | |
| identifier | length | format | seed | indication | indication | GI | TA | RA | information | information | . . . |
| Second | 1 | HT | . . . | . . . | . . . | . . . | . . . | . . . | . . . | . . . | . . . |
| element | | | | | | | | | | | |
| identifier | | | | | | | | | | | |

TABLE 15

| | Physical | | | | | | | | | |
|---|---|---|---|---|---|---|---|---|---|---|
| | layer | | | | | | | First | First | |
| Control | packet | Scrambler | STBC | DCM | | | | time | channel | |
| identifier | format | seed | indication | indication | GI | TA | RA | information | information | . . . |
| Second | HT | . . . | . . . | . . . | . . . | . . . | . . . | . . . | . . . | . . . |
| control | | | | | | | | | | |
| identifier | | | | | | | | | | |

5052. The control device adds the MBSFN information to a beacon frame, and sends the beacon frame and the multicast data to the plurality of forwarding devices.

The control device may first send the beacon frame to the forwarding device, and after the forwarding device receives the beacon frame and obtains the MBSFN information, the control device sends the multicast data to the forwarding device.

The beacon frame is also referred to as a beacon frame, and is a MAC frame periodically sent by the control device to the forwarding device. The MBSFN information is carried in the beacon frame such that the forwarding device can be periodically notified of the MBSFN information.

5053. The control device adds the MBSFN information to connection information, and sends the connection information and the multicast data to the plurality of forwarding devices.

The control device may first send the connection information to the forwarding device, and after the forwarding device receives the connection information and obtains the MBSFN information, the control device sends the multicast data to the forwarding device.

When each of the plurality of forwarding devices needs to establish a connection to the control device, the control device sends connection information to the forwarding devices, where the connection information is used to instruct the forwarding devices to establish a connection to the control device. After receiving the connection information, the forwarding device may establish a connection to the control device and learn the MBSFN information.

506. The plurality of forwarding devices receive the multicast data and obtain the MBSFN information.

In this embodiment, the forwarding device may receive the MBSFN information sent by the control device. Based on different manners of sending the MBSFN information in the foregoing step 505, the step of receiving the MBSFN information may include any one of the following steps S061 to S063.

5061. The forwarding device parses the multicast data to obtain the MBSFN information carried in the multicast data.

Corresponding to the foregoing step S051, the forwarding device may obtain the MBSFN information from the received multicast data, that is, obtain the MBSFN information from the information element or the frame header of the MAC frame.

5062. The forwarding device receives the beacon frame sent by the control device, and parses the beacon frame to obtain the MBSFN information carried in the beacon frame.

Step S062 corresponds to the foregoing step S052. After obtaining the MBSFN information carried in the beacon frame, the forwarding device may store the MBSFN information. Subsequently, when receiving the multicast data, the forwarding device may obtain the stored MBSFN information.

5063. The forwarding device receives the connection information sent by the control device, and parses the connection information to obtain the MBSFN information carried in the connection information.

Step S063 corresponds to the foregoing step S053. After obtaining the MBSFN information carried in the connection information, the forwarding device may store the MBSFN information. Subsequently, when receiving the multicast data, the forwarding device may obtain the stored MBSFN information.

It should be noted that, in the foregoing step 504, after the plurality of forwarding devices send the device statistical information to the control device, the control device may perform any one of the foregoing steps S051 to S053, that is, return the MBSFN information to the forwarding devices such that the forwarding devices receive the MBSFN information.

In another embodiment, the forwarding device may directly obtain prestored default MBSFN information, where the default MBSFN information may be set in the forwarding device by a developer. In this case, the forwarding device and the control device do not need to perform steps 501 to 506, but instead, the control device directly sends the multicast data to the plurality of forwarding devices, and the forwarding device receives the multicast data and obtains the default MBSFN information.

507. The plurality of forwarding devices send the multicast data to at least one station device in the first data sending manner on the first channel at the first time point.

For a process of determining the first time point, each of the plurality of forwarding devices parses the MBSFN information to obtain the first time information, and determines the first time point based on the first time information. The process of determining the first time point may include any one of the following steps S071 to S073.

5071. When the first time information carries the specified time interval, the forwarding device may obtain the specified time interval carried in the first time information, and use a time point at the end of the specified time interval starting from a time point at which the multicast data is received as the first time point. The forwarding device starts timing when receiving the multicast data. When a specified time interval expires, and that the first time point arrives, the forwarding device sends the multicast data at this time. The specified time interval may be a short inter-frame space (Short Inter-Frame Space, SIFS), a point coordination function inter-frame space (Point Coordination Function Inter-Frame Space, PIFS), or the like.

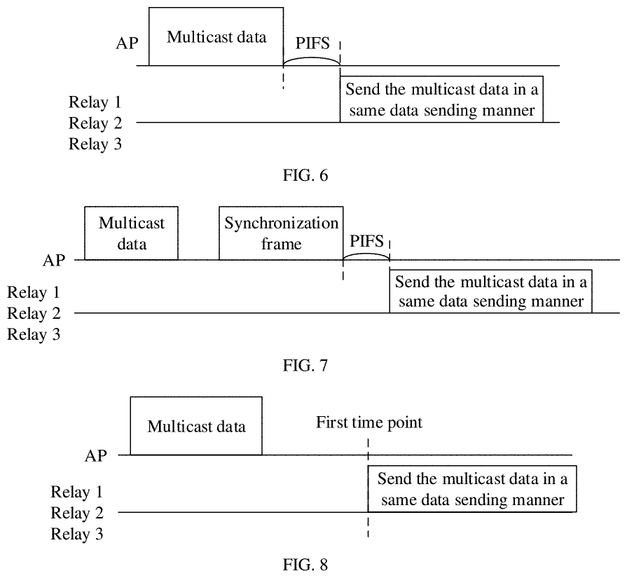

For example, the specified time interval is the PIFS, the control device is an AP, and the plurality of forwarding devices are a relay 1, a relay 2, and a relay 3 respectively. A schematic diagram of a multicast data transmission process may be shown in FIG. 6.

5072. When the specified time interval is carried in the first time information, the forwarding device may receive the synchronization frame sent by the control device, and use a time point at the end of the specified time interval starting from a time point at which the synchronization frame is received as the first time point. After sending the multicast data to the forwarding device, the control device sends the synchronization frame to the forwarding device. The forwarding device starts timing when receiving the synchronization frame. When the specified time interval expires, and that the first time point arrives, the forwarding device sends the multicast data at this time.

For example, the specified time interval is the PIFS, the control device is an AP, and the plurality of forwarding devices are a relay 1, a relay 2, and a relay 3 respectively. A schematic diagram of a multicast data transmission process may be shown in FIG. 7.

5073. When the first time point is carried in the first time information, the forwarding device may directly obtain the first time point carried in the first time information, and send the multicast data when the first time point arrives. For example, the control device is an AP, and the plurality of forwarding devices are a relay 1, a relay 2, and a relay 3 respectively. A schematic diagram of a multicast data transmission process may be shown in FIG. 8.

In a process of determining the first channel, each of the plurality of forwarding devices parses the MBSFN information to obtain the first channel information, and determines the first channel based on the first channel information, that is, determines the corresponding first channel based on an identifier of the first channel in the first channel information. In addition, the MBSFN information may alternatively instruct the forwarding device to obtain a default first channel. The default first channel may be a channel used by the control device to send the multicast data to the forwarding device.

For a process of determining the first data sending manner, each of the plurality of forwarding devices parses the MBSFN information to obtain at least one of the physical layer packet format, the TA, the RA, the bandwidth, the GI, the scrambler seed, the STBC identifier, or the DCM identifier included in the MBSFN information in order to determine the first data sending manner.

When the MBSFN information includes the physical layer packet format, the forwarding device uses the physical layer packet format included in the MBSFN information as a physical layer packet format used to send the multicast data. For example, if the MBSFN information includes the VHT format, that the multicast data is to be sent in the VHT format. In addition, the forwarding device may store a default physical layer packet format, the MBSFN information may instruct the forwarding device to use the default physical layer packet format, where the default physical layer packet format may be a physical layer packet format used by the control device to send the multicast data to the forwarding device.

When the MBSFN information includes the TA and the RA, the forwarding device adds the TA and the RA of the MBSFN information to the multicast data. In addition, the MBSFN information may instruct the forwarding device to use a default TA and a default RA. The forwarding device obtains the MAC address of the control device as the default TA, obtains the broadcast MAC address as the default RA, and adds the default TA and RA to the multicast data such that the multicast data is sent to the at least one station device in a broadcast manner.

When the MBSFN information includes the bandwidth, the forwarding device uses the bandwidth included in the MBSFN information as the bandwidth used to send the multicast data. In addition, the MBSFN information may instruct the forwarding device to use default bandwidth, where the default bandwidth may be bandwidth used by the control device to send the multicast data to the forwarding device.

When the MBSFN information includes the GI, the forwarding device uses the GI included in the MBSFN information as a GI used to send the multicast data. In addition, when the MBSFN information does not include the GI, to avoid intercode interference and improve robustness in a multicast data transmission process, the control device may select a relatively large GI. For example, if a determined physical layer packet format is the HE format, a GI of 3.2 us is determined as the GI. If the determined physical layer packet format is not the HE format, a GI of 0.8 us is determined as the GI. In addition, the MBSFN information may instruct the forwarding device to use a default GI, where the default GI may be a GI used by the control device to send the multicast data to the forwarding device.

When the MBSFN information includes the scrambler seed, the forwarding device uses the scrambler seed included in the MBSFN information as a scramble code seed used to send the multicast data. In addition, when the MBSFN information does not include the scrambler seed, the forwarding device may obtain a scrambler seed used when the control device sends the multicast data to the forwarding device, and scramble the multicast data.

When the MBSFN information includes the STBC identifier, when the STBC identifier is the first identifier, the forwarding device sends the multicast data in the STBC manner; and when the STBC identifier is the second identifier, the forwarding device does not send the multicast data in the STBC manner. In addition, the MBSFN information may instruct the forwarding device to determine, based on a default setting, whether to use the STBC manner. For example, the forwarding device may determine whether the control device sends the multicast data to the forwarding device in the STBC manner. If the control device sends the multicast data to the forwarding device in the STBC manner, the forwarding device also sends the multicast data to the station device in the STBC manner.

When the MBSFN information includes the DCM identifier, when the DCM identifier is the first identifier, the forwarding device sends the multicast data in the DCM manner; and when the STBC identifier is the second identifier, the forwarding device does not send the multicast data in the DCM manner. In addition, the MBSFN information may instruct the forwarding device to determine, based on a default setting, whether to use the DCM manner. For example, the forwarding device may determine whether the control device sends the multicast data to the forwarding device in the DCM manner. If the control device sends the multicast data to the forwarding device in the DCM manner, the forwarding device also sends the multicast data to the station device in the DCM manner.

In addition, for a parameter not included in the MBSFN information, the forwarding device may select a parameter of relatively strong robustness by default on a premise of ensuring robustness of multicast data transmission. For example, for a quantity of spatial streams used for sending the multicast data, because less spatial streams indicate stronger robustness, the forwarding device selects 1 by default as a determined quantity of spatial streams.

It should be noted that, that the forwarding device directly sends the multicast data is used as an example in the foregoing process. In another embodiment, the forwarding device may sense the first channel to determine a status of the first channel. When the first channel is in an idle state, the forwarding device sends the multicast data in the first data sending manner on the first channel at the first time point, when the first channel is in a busy state, the multicast data is not sent at the first time point. In this case, a data sending manner of the multicast data is determined by the forwarding device.

For a process of sensing the first channel, the forwarding device may detect energy of the first channel using a physical carrier sense mechanism. When the energy of the first channel is relatively low, that the first channel is in an idle state, and when the energy of the first channel is relatively high, that the first channel is in a busy state.

Alternatively, the forwarding device may detect a configured network allocation vector (NAV) using a virtual carrier sense mechanism. When it is detected that a NAV is 0, that the first channel is in an idle state, and when it is detected that the NAV is not 0, that the first channel is in a busy state. The NAV serves as a timer, used to indicate expected duration during which the first channel is occupied. Certainly, both the two mechanisms may be used. To be specific, when the energy of the first channel is relatively low and it is detected that the NAV is 0, that the first channel is in the idle state.

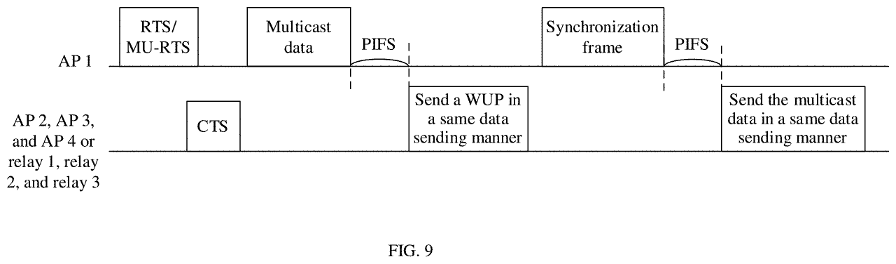

To avoid interference to multicast data in a transmission process, a NAV of each forwarding device may be preconfigured using an RTS mechanism or a CTS mechanism. Referring to FIG. 9, before sending the multicast data, the control device (AP 1) first sends a request to send (RTS) frame or a multi-user request (Multiple User RTS, MU-RTS) frame to each of the plurality of forwarding devices (AP 2, AP 3, and AP 4, or relay 1, relay 2, and relay 3). After receiving the RTS frame or the MU-RTS frame, each forwarding device is configured with a NAV whose initial value is not 0, and returns a clear to send (CTS) frame to the control device. After receiving the CTS frame, the control device sends the multicast data.

Before the multicast data is sent, because each forwarding device is preconfigured a NAV whose initial value is not 0, the forwarding device determines that the first channel is in a busy state, and does not occupy the first channel to transmit the data. Therefore, when the multicast data is to be sent at the same time, there is no other data being transmitted on the first channel. This ensures that transmission of the multicast data is not interfered.

It should be noted that, when a forwarding device has started transmitting data on the first channel when no NAV is configured or a NAV is to be configured, or another device other than the plurality of forwarding devices transmits data on the first channel, the first channel is in a busy state. In this case, if the forwarding device detects that the first channel is in a busy state, the forwarding device contends for the first channel, and sends the multicast data after obtaining the first channel through contention. Specifically, the forwarding device waits. When a channel is in an idle state, a random counter value is generated and decreased over time. During this period, if another forwarding device occupies the channel, and consequently, the channel is switched to a busy state, the forwarding device suspends a decrease in the counter value. Subsequently, when the channel is switched back to an idle state, the forwarding device resumes decreasing the counter value from a previously suspended counter value, until the counter value is decreased to 0, which indicates that the forwarding device obtains the channel through contention, and may send multicast data on the channel in a self-determined data sending manner.

508. Each of the at least one station device receives the multicast data.

According to the method provided in this embodiment, the plurality of forwarding devices obtain same MBSFN information, and can send the multicast data in a same data sending manner on a same channel at a same time point based on the same MBSFN information. In this way, no interference is caused between different forwarding devices. In addition, the forwarding devices each do not need to contend for a channel. This shortens a time expended in sending the multicast data and improves efficiency in sending the multicast data. For the plurality of forwarding devices, because the plurality of forwarding devices send data on a channel at the same time rather than send the data in turn, efficiency in sending the multicast data is also improved.

In an embodiment, the plurality of forwarding devices may sense a channel to determine a status of the channel. When the channel is in an idle state, the multicast data is sent at a same time point; when the channel is in a busy state, the multicast data is not sent at a same time point. This avoids interference caused by other data on the channel to a multicast data transmission process, and prevents signal collision between cells.

In an embodiment, considering that data sending manners supported by different station devices may be different, a data sending manner supported by all the station devices is used as a data sending manner to send the multicast data, or a data sending manner supported by more than a specified quantity of station devices is used as a data sending manner to send the multicast data, to ensure that as many station devices as possible successfully receive the multicast data as possible, and improve efficiency in sending the multicast data.

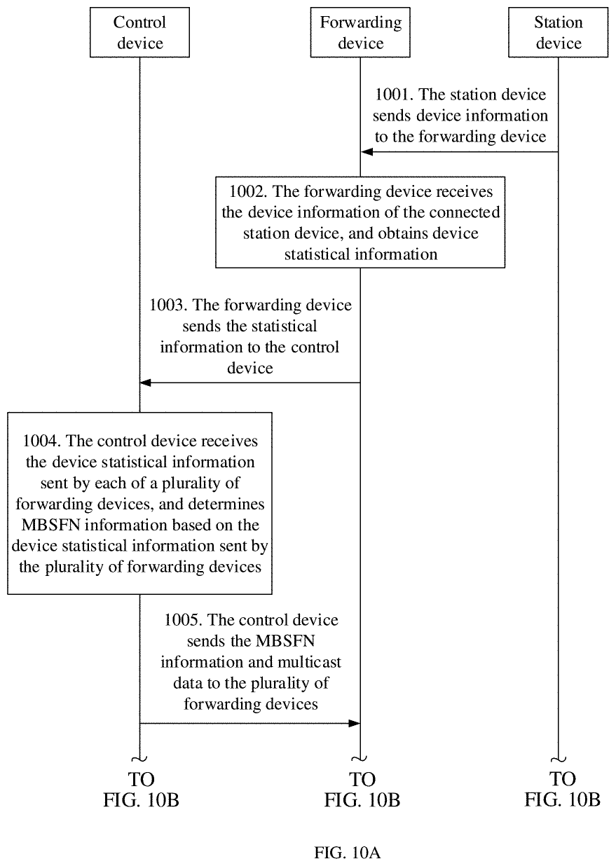

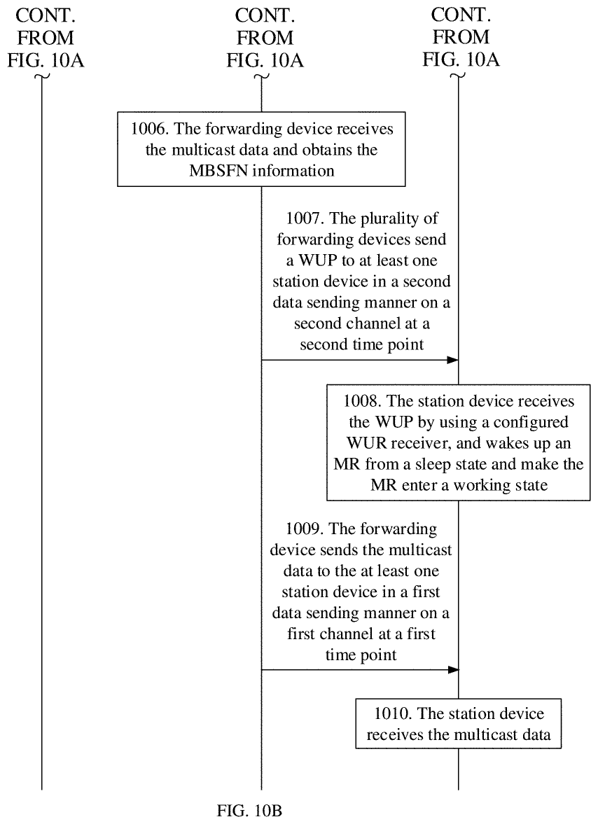

On a basis of the embodiment in FIG. 5, a case that currently many station devices enter a deep sleep state when no data is received or sent, and the station device in the deep sleep state cannot communicate with the forwarding device is taken into consideration. In this case, a wake-up data packet (Wake Up Packet, WUP) needs to be first sent to the station device, to wake up the station device, and then the multicast data is sent to the station device. Therefore, an embodiment of this disclosure in an embodiment provides a multicast data sending method. In this method, before sending the multicast data, a plurality of forwarding devices may send the WUP in a uniform data sending manner on a uniform channel at a uniform time point. FIG. 10A and FIG. 10B show a flowchart of a multicast data sending method, and the method specifically includes the following steps.

1001. The station device sends device information to the forwarding device.

This step is similar to step 201 with a difference lying in that the device information in an embodiment includes an indication indicating whether the WUP is requested, and the device information may include a field corresponding to the indication indicating whether the WUP is requested. A first identifier in the field is used to indicate that the station device requests the WUP, and the control device needs to first send the WUP and then send the multicast data. A second identifier in the field is used to indicate that the station device does not request the WUP, and the control device can directly send the multicast data without sending the WUP. The field may be shown in the following Table 16.

TABLE 16
Indication indicating whether the WUP is requested
1

1002. The forwarding device receives the device information of the connected station device, and obtains device statistical information.

This step is similar to step 502 with a difference lying in that the device statistical information includes a field corresponding to the WUP, to indicate whether a station device requesting the WUP exist, or indicate a quantity of station devices requesting the WUP.

In a possible implementation, the device statistical information includes the field corresponding to the WUP, where in the field, the first identifier is used to indicate that the station device requesting the WUP exists, and the second identifier is used to indicate that the station device requesting the WUP does not exist. In this way, it is ensured that the device statistical information indicates whether the station device requesting the WUP exists in a station device connected to the forwarding device. Therefore, when at least one station device in the station device connected to the forwarding device requests the WUP, the forwarding device adds the first identifier to the field, while when none of the station device connected to the forwarding device requests the WUP, the forwarding device adds the second identifier to the field. For example, if the forwarding device is connected to 100 station devices, provided that one station device in the 100 station devices requests the WUP, 1 is added to the field corresponding to the WUP. If none of the 100 station devices requests the WUP, 0 is added to the field corresponding to WUP.

For example, the device statistical information may include information shown in the following Table 17, where “WUP Indication Request” is the field corresponding to the WUP, and the identifier 1 in the field indicates that the station device requesting the WUP exists.

TABLE 17
WUP indication request
1

In another possible implementation, the device statistical information includes the field corresponding to the WUP, and a value carried in the field represents a quantity of station devices requesting the WUP. In this way, it is ensured that the device statistical information indicates the quantity of station devices requesting the WUP in the station device connected to the forwarding device. Therefore, the forwarding device counts, based on the station device information of the station device connected to the forwarding device, a quantity of station devices requesting the WUP in the station devices, and adds the quantity of station devices to the field.

For example, the device statistical information may include information shown in the following Table 18. A “WUP Indication Request number” field is the field corresponding to WUP, and a value 20 carried in the field indicates that 20 station devices request the WUP.

TABLE 18
WUP indication request number
20

1003. The forwarding device sends the device statistical information to the control device.

This step is similar to the foregoing step 503.

1004. The control device receives the device statistical information sent by each of the plurality of forwarding devices, and determines MBSFN information based on the device statistical information sent by the plurality of forwarding devices.

This step is similar to the foregoing step 504. A difference lies in, when the control device determines that all station devices connected to the plurality of forwarding devices request the WUP, or when the control device determines that more than a specified quantity of station devices in the forwarding devices connected to the plurality of forwarding devices request the WUP, that the plurality of forwarding devices need to send the WUP in a same second data sending manner on a same second channel at a same second time point, and the determined MBSFN information is in an embodiment used to instruct the plurality of forwarding devices to send the WUP to the station device and indicate the same second data sending manner, the same second channel, and the same second time point that are used to send the WUP.

A step of determining the second channel is similar to the step of determining the first channel in step S041, a step of determining the second time point is similar to the step of determining the first time point in step S042, and a step of determining the second data sending manner is similar to the step of determining the first data sending manner in step S043.

Correspondingly, compared with the MBSFN information in the embodiment in FIG. 5, the MBSFN information determined in this embodiment includes a WUP identifier, second channel information, second time information, and the second data sending manner.

The WUP identifier may be carried in a field in the MBSFN information, for example, a “WUP Needed” field. The WUP identifier indicates, using the first identifier, that the forwarding device first sends the WUP and then sends the multicast data, and the second identifier indicates that the forwarding device directly sends the multicast data without sending the WUP.

The second channel information may be carried in a field in the MBSFN information, is used to indicate the second channel, and may be a name, a number, or the like of the second channel.

The second time information may be carried in a field in the MBSFN information. The second time information may carry a specified time interval, and that a time point at the end of the specified time interval starting from a time point at which the forwarding device receives the multicast data is the second time point. Alternatively, the second time information carries a specified time interval, and that a time point at the end of the specified time interval starting from a time point at which the forwarding device receives a synchronization frame is the second time point. Alternatively, the second time information may also carry the second time point.

The second data sending manner includes at least one of a physical layer packet format used for sending the WUP, a TA used for sending the WUP, an RA used for sending the WUP, bandwidth used for sending the WUP, a GI used for sending the WUP, a scrambler seed used for sending the WUP, an STBC identifier used to indicate whether the WUP is sent in an STBC manner, and a DCM identifier used to indicate whether the WUP is sent in a DCM manner.

1005. The control device sends the MBSFN information and the multicast data to the plurality of forwarding devices.

This step is similar to the foregoing step 505. Details are not described herein again.

1006. The plurality of forwarding devices receive the multicast data and obtain the MBSFN information.

This step is similar to the foregoing step 506, that is, the forwarding device may receive the multicast data to obtain the MBSFN information in order to determine the MBSFN information. Alternatively, the forwarding device may receive a beacon frame or connection information to obtain the MBSFN information, or prestore the MBSFN information, and when the multicast data is received, obtain the prestored MBSFN information. A difference lies in that when the forwarding device parses the MBSFN information, and determines that the MBSFN information instructs to send the WUP and indicates the second channel and the second time point that are used to send the WUP, the forwarding device performs the following step 1007; or when the forwarding device determines that the MBSFN information instructs not to send the WUP, the forwarding device does not perform step 1007, but directly performs the following step 1009 instead.

1007. The plurality of forwarding devices send the WUP to at least one station device in the second data sending manner on the second channel at the second time point.

Each of the plurality of forwarding devices parses the second time information in the MBSFN information to determine the second time point.

In a first possible implementation, the second time information carries a specified time interval, the forwarding device obtains the specified time interval, and uses a time point at the end of the specified time interval starting from a time point at which the multicast data is received as the second time point. The forwarding device starts timing when receiving the multicast data. When the specified time interval expires, and that the second time point arrives, the forwarding device sends the WUP at this time, where the specified time interval may be SIFS, PIFS, or the like.

In a second possible implementation, the second time information carries a specified time interval, the forwarding device obtains the specified time interval, and uses a time point at the end of the specified time interval starting from a time point at which the synchronization frame is received as the second time point. After sending the multicast data to the forwarding device, the control device sends the synchronization frame to the forwarding device. The forwarding device starts timing when receiving the synchronization frame. When the specified time interval expires, and that the second time point arrives, the forwarding device sends the WUP at this time.

In a third possible implementation, the second time information has carried the second time point, and the forwarding device can obtain the second time point without determining the second time point through timing.

A first point worth noting is that the specified time interval carried in the second time information and the specified time interval carried in the first time information may be the same or different, and specific values thereof are determined based on an actual requirement.

A second point worth noting is that, an example in which when the MBSFN information instructs to send the WUP and indicates the second channel and the second time point that are used to send the WUP, the forwarding device directly sends the WUP is used in the foregoing process. In another embodiment, when the MBSFN information instructs to send the WUP and indicates the second channel and the second time point that are used to send the WUP, the forwarding device may sense the second channel to determine a status of the channel, and when the second channel is in an idle state, the forwarding device sends the multicast data in the second data sending manner on the second channel at the second time point. When the second channel is in a busy state, the multicast data is not sent at the second time point. In this case, the forwarding device determines whether to send the WUP, and determines the second data sending manner when determining to send the WUP.

1008. Each of the at least one station device receives the WUP using a configured WUR receiver, and wakes up the MR from a sleep state, making the MR enter a working state.

1009. The plurality of forwarding devices send the multicast data to the at least one station device in the first data sending manner on the first channel at the first time point.

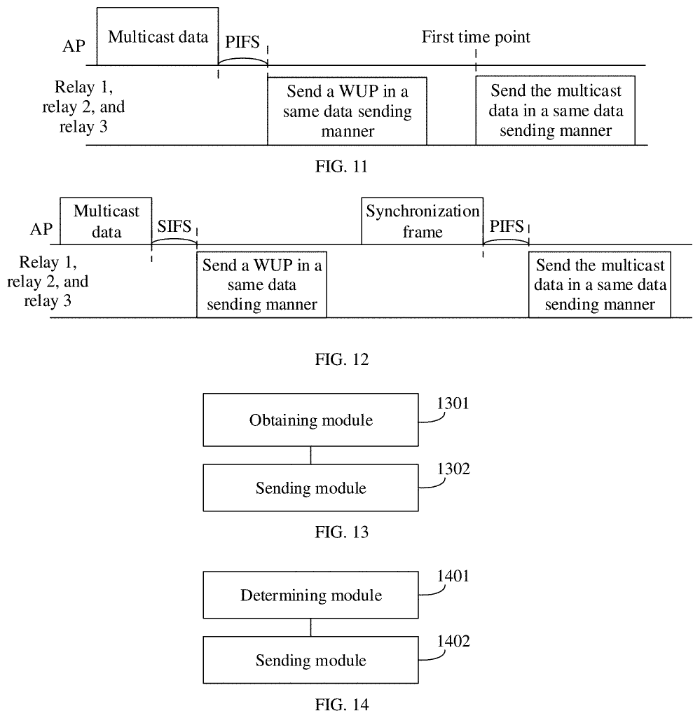

This step is similar to the foregoing step 507. For example, the control device is an AP, and the plurality of forwarding devices are a relay 1, a relay 2, and a relay 3. When the second time information indicates a time point at the end of the PIFS starting from a time point at which the multicast data is received, and the first time information carries a first time point, a schematic diagram of a multicast data transmission process may be shown in FIG. 11. For example, the second time information indicates a time point at the end of the SIFS starting from a time point at which the multicast data is received, and the first time information indicates a time point at the end of the PIFS from a time point at which the synchronization frame is received. A schematic diagram of a multicast data transmission process may be shown in FIG. 12.

1010. Each of the at least one station device receives the multicast data.

That the station device receives the multicast data actually means that the configured MR of the station device receives the multicast data. After receiving the multicast data, the MR enters the deep sleep state to save power.

According to the method provided in this embodiment, the plurality of forwarding devices send a WUP in a same data sending manner on a same channel at a same time point. In this way, no interference is caused between different forwarding devices. In addition, the forwarding devices each do not need to contend for a channel. This reduces a time expended in sending the WUP, and improve efficiency in sending the WUP. For the plurality of forwarding devices, because the plurality of forwarding devices send the WUP on a channel at the same time rather than send the WUP in turn, efficiency in sending the WUP is also improved.

FIG. 13 is a schematic structural diagram of a multicast data sending apparatus according to an exemplary embodiment. As shown in FIG. 13, the apparatus includes an obtaining module 1301 and a sending module 1302.

The obtaining module 1301 is configured to obtain multicast-broadcast single-frequency network MBSFN information, where the MBSFN information is used to indicate a same first data sending manner, a same first channel, and a same first time point that are used when a plurality of forwarding devices send multicast data, and the multicast data is received from a control device.

The sending module 1302 is configured to forward the multicast data to at least one station device in the first data sending manner on the first channel at the first time point.

According to the apparatus provided in this embodiment, the plurality of forwarding devices obtain same MBSFN information, and can send the multicast data in a same data sending manner on a same channel at a same time point based on the same MBSFN information. In this way, no interference is caused between different forwarding devices. In addition, the forwarding devices each do not need to contend for a channel. This shortens a time expended in sending the multicast data and improves efficiency in sending the multicast data. For the plurality of forwarding devices, because the plurality of forwarding devices send data on a channel at the same time rather than send the data in turn, efficiency in sending the multicast data is also improved.

In a possible implementation, the MBSFN information is in an embodiment used to instruct the plurality of forwarding devices to send a wake-up data packet WUP to a station device and indicate a same second data sending manner, a same second channel, and a same second time point that are used to send the WUP.

The sending module 1302 is in an embodiment configured to send the WUP to the at least one station device in the second data sending manner on the second channel at the second time point, and perform the step of sending the multicast data to at least one station device on the first channel at the first time point such that each of the at least one station device receives the WUP using a configured wake-up radio WUR receiver, wakes up a main radio MR from a sleep state, making the MR into a working state, and receives the multicast data using the MR.

In another possible implementation, the MBSFN information includes first channel information, first time information, and the first data sending manner, and the first data sending manner includes at least one of a physical layer packet format, a TA, a RA, bandwidth, a GI, a scrambler seed, a STBC identifier, and a DCM identifier.

The first channel information is used to indicate the first channel, the first time information is used to indicate the first time point, the physical layer packet format is used to indicate a same physical layer packet format used when the plurality of forwarding devices send the multicast data, the TA is used to indicate a same TA used when the plurality of forwarding devices send the multicast data, the RA is used to indicate a same RA used when the plurality of forwarding devices send the multicast data, the bandwidth is used to indicate same bandwidth used when the plurality of forwarding devices send the multicast data, the GI is used to indicate a same GI used when the plurality of forwarding devices send the multicast data, the scrambler seed is used to indicate a same scrambler seed used when the plurality of forwarding devices send the multicast data, the STBC identifier is used to indicate whether the plurality of forwarding devices send the multicast data in an STBC manner, and the DCM identifier is used to indicate whether the plurality of forwarding devices send the multicast data in a DCM manner.

In another possible implementation, the apparatus in an embodiment includes a receiving module configured to receive device information of a station device connected to the forwarding device, where the device information includes at least one of a supported wireless local area network WLAN protocol, an indication indicating whether STBC is supported, and an indication indicating whether DCM is supported, and the device information is used to indicate a data sending manner supported by the station device.

The sending module 1302 is in an embodiment configured to send device statistical information to the control device, where the device statistical information is used to indicate at least one of the following such as whether a station device that supports each WLAN protocol exists in the station device connected to the forwarding device, whether a station device that does not support the STBC exists in the station device connected to the forwarding device, and whether a station device that does not support the DCM exists in the station device connected to the forwarding device; or the device statistical information is used to indicate at least one of a quantity of station devices that support each WLAN protocol in the station device connected to the forwarding device, a quantity of station devices that do not support the STBC in the station device connected to the forwarding device, and a quantity of station devices that do not support the DCM in the station device connected to the forwarding device such that the control device determines the MBSFN information based on the device statistical information sent by the plurality of forwarding devices, and returns the MBSFN information to the forwarding devices.

In another possible implementation, the obtaining module 1301 is in an embodiment configured to parse the multicast data to obtain the MBSFN information carried in the multicast data.

The obtaining module 1301 is in an embodiment configured to receive a beacon frame sent by the control device, and parses the beacon frame to obtain the MBSFN information carried in the beacon frame.

The obtaining module 1301 is in an embodiment configured to, after device statistical information is sent to the control device, receive the MBSFN information returned by the control device, where the MBSFN information is determined by the control device based on the device statistical information sent by the plurality of forwarding devices.

The obtaining module 1301 is in an embodiment configured to receive connection information sent by the control device, and parse the connection information to obtain the MBSFN information carried in the connection information, where the connection information is used to instruct the forwarding device to establish a connection to the control device.

The obtaining module 1301 is in an embodiment configured to obtain prestored default MBSFN information.

In another possible implementation, the MBSFN information includes the first time information, where the first time information is used to indicate the first time point.

The obtaining module 1301 is in an embodiment configured to obtain a specified time interval carried in the first time information, and use a time point at the end of the specified time interval starting from a time point at which the multicast data is received as the first time point.

The obtaining module 1301 is in an embodiment configured to obtain a specified time interval carried in the first time information, receive a synchronization frame sent by the control device, and use a time point at the end of the specified time interval starting from a time point at which the synchronizing frame is received as the first time point.

The obtaining module 1301 is in an embodiment configured to obtain the first time point carried in the first time information.

In another possible implementation, the sending module 1302 is in an embodiment configured to perform the step of sending the multicast data to at least one station device in the first data sending manner on the first channel at the first time point when the first channel is in an idle state.

The sending module 1302 is in an embodiment configured to skip sending the multicast data at the first time point when the first channel is in a busy state.

In another possible implementation, the control device is an AP, and the plurality of forwarding devices are a plurality of relays relays connected to the AP.

The control device is a specified AP in a plurality of APs, and the plurality of forwarding devices are a plurality of APs other than the specified AP in the plurality of APs.

The control device is an AC, and the plurality of forwarding devices are a plurality of APs connected to the AC.

FIG. 14 is a schematic structural diagram of a multicast data sending apparatus according to an exemplary embodiment, where the apparatus is applied to a control device, and includes a determining module 1401 and a sending module 1402.

The determining module 1401 is configured to determine MBSFN information, where the MBSFN information is used to indicate a same first data sending manner, a same first channel, and a same first time point that are used when a plurality of forwarding devices send multicast data.

The sending module 1402 is configured to send the MBSFN information and the multicast data to the plurality of forwarding devices such that each of the plurality of forwarding devices sends the multicast data to at least one station device in the first data sending manner on the first channel at the first time point.

According to the apparatus provided in this embodiment, the plurality of forwarding devices obtain same MBSFN information, and can send the multicast data in a same data sending manner on a same channel at a same time point based on the same MBSFN information. In this way, no interference is caused between different forwarding devices. In addition, the forwarding devices each do not need to contend for a channel. This shortens a time expended in sending the multicast data and improves efficiency in sending the multicast data. For the plurality of forwarding devices, because the plurality of forwarding devices send data on a channel at the same time rather than send the data in turn, efficiency in sending the multicast data is also improved.

In another possible implementation, the MBSFN information includes first channel information, first time information, and the first data sending manner, and the first data sending manner includes at least one of a physical layer packet format, a TA, a RA, bandwidth, a GI, a scrambler seed, a STBC identifier, and a DCM identifier.

The MBSFN information is in an embodiment used to instruct the plurality of forwarding devices to send a wake-up data packet WUP to a station device and indicate a same second data sending manner, a same second channel, and a same second time point that are used to send the WUP, the first channel information is used to indicate the first channel, the first time information is used to indicate the first time point, the physical layer packet format is used to indicate a same physical layer packet format used when the plurality of forwarding devices send the multicast data, the TA is used to indicate a same TA used when the plurality of forwarding devices send the multicast data, the RA is used to indicate a same RA used when the plurality of forwarding devices send the multicast data, the bandwidth is used to indicate same bandwidth used when the plurality of forwarding devices send the multicast data, the GI is used to indicate a same GI used when the plurality of forwarding devices send the multicast data, the scrambler seed is used to indicate a same scrambler seed used when the plurality of forwarding devices send the multicast data, the STBC identifier is used to indicate whether the plurality of forwarding devices send the multicast data in an STBC manner, and the DCM identifier is used to indicate whether the plurality of forwarding devices send the multicast data in a DCM manner.

In another possible implementation, the apparatus includes a receiving module configured to receive device statistical information sent by each of the plurality of forwarding devices, where the device statistical information is used to indicate at least one of the following such as whether a station device that supports each WLAN protocol exists in a station device connected to a related forwarding device, whether a station device that does not support the STBC exists in the station device connected to the related forwarding device, and whether a station device that does not support the DCM exists in the station device connected to the related forwarding device; or the device statistical information is used to indicate at least one of a quantity of station devices that support each WLAN protocol in the station device connected to the related forwarding device, a quantity of station devices that do not support the STBC in the station device connected to the related forwarding device, and a quantity of station devices that do not support the DCM in the station device connected to the related forwarding device; where the determining module 1401 is in an embodiment configured to determine, based on the device statistical information sent by the plurality of forwarding devices, a data sending manner supported by the station devices connected to the plurality of forwarding devices; and the determining module 1401 is in an embodiment configured to determine the MBSFN information based on the data sending manner supported by all the station devices connected to the plurality of forwarding devices; or the determining module 1401 is in an embodiment configured to determine the MBSFN information based on a data sending manner supported by more than a specified quantity of station devices in the station devices connected to the plurality of forwarding devices.

In another possible implementation, the sending module 1402 is in an embodiment configured to add the MBSFN information to the multicast data, and send the multicast data that carries the MBSFN information to the plurality of forwarding devices; or the sending module 1402 is in an embodiment configured to add the MBSFN information to a beacon frame, and send the beacon frame and the multicast data to the plurality of forwarding devices; or the sending module 1402 is in an embodiment configured to add the MBSFN information to connection information, and send the connection information and the multicast data to the plurality of forwarding devices, where the connection information is used to instruct each of the plurality of forwarding devices to establish a connection to the control device.

In another possible implementation, the control device is an AP, and the plurality of forwarding devices are a plurality of relays relays connected to the AP.

Alternatively, the control device is a specified AP in a plurality of APs, and the plurality of forwarding devices are a plurality of APs other than the specified AP in the plurality of APs.

Alternatively, the control device is an AC, and the plurality of forwarding devices are a plurality of APs connected to the AC.

All the foregoing optional technical solutions may be combined into an optional embodiment of this disclosure in any manner, and details are not described herein.

It should be noted that when the multicast data sending apparatuses provided in the foregoing embodiments send multicast data, division of the foregoing function modules is used only as an example for description. In an example application, the foregoing functions may be allocated to different function modules as required for completion, that is, internal structures of the control device and the forwarding device are divided into different function modules to complete all or some of the described functions. In addition, the foregoing embodiments of the multicast data sending apparatuses and the embodiments of the multicast data sending method pertain to a same concept. For a specific implementation process, refer to the method embodiments. Details are not described herein again.

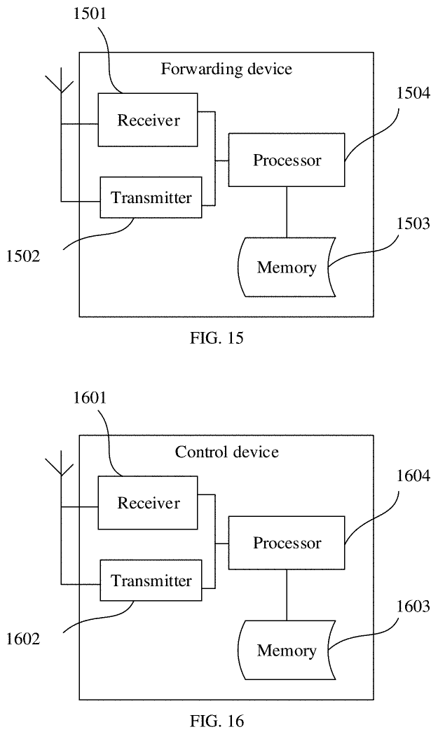

FIG. 15 is a schematic structural diagram of a forwarding device according to an embodiment of this disclosure. Referring to FIG. 15, the forwarding device includes a receiver 1501, a transmitter 1502, a memory 1503, and a processor 1504, where the receiver 1501, the transmitter 1502, and the memory 1503 are separately connected to the processor 1504, the memory 1503 stores at least one instruction, and the processor 1504 is configured to load and execute the at least one instruction, to implement operations performed by the forwarding device in the foregoing embodiments.

FIG. 16 is a schematic structural diagram of a control device according to an embodiment of this disclosure. Referring to FIG. 16, the control device includes a receiver 1601, a transmitter 1602, a memory 1603, and a processor 1064, where the receiver 1601, the transmitter 1602, and the memory 1603 are separately connected to the processor 1604, the memory 1603 stores at least one instruction, and the processor 1604 is configured to load and execute the at least one instruction, to implement operations performed by the control device in the foregoing embodiments.

An embodiment of this disclosure provides a computer-readable storage medium, where the computer-readable storage medium stores at least one instruction, and the instruction is loaded and executed by a processor to implement operations performed by the forwarding device in the multicast data sending methods described in the foregoing embodiments. For example, the computer-readable storage medium may be a read-only memory (ROM), a random access memory (RAM), a compact disc ROM (CD-ROM), a magnetic tape, a floppy disk, an optical data storage device, or the like.

An embodiment of this disclosure provides a computer-readable storage medium, where the computer-readable storage medium stores at least one instruction, and the instruction is loaded and executed by a processor to implement operations performed by the control device in the multicast data sending methods described in the foregoing embodiments. For example, the computer-readable storage medium may be a ROM, a RAM, a CD-ROM, a magnetic tape, a floppy disk, an optical data storage device, or the like.

An embodiment of this disclosure provides a computer program product including an instruction, where when the computer program product runs on a control device, the control device is enabled to implement the operations performed by the control device in the multicast data sending methods in the foregoing embodiments.

An embodiment of this disclosure provides a computer program product including an instruction, where when the computer program product runs on a forwarding device, the forwarding device is enabled to implement the operations performed by the forwarding device in the multicast data sending methods in the foregoing embodiments.

A person of ordinary skill in the art may understand that all or some of the steps of the embodiments may be implemented by hardware or a program instructing related hardware. The program may be stored in a computer-readable storage medium. The storage medium may include a read-only memory, a magnetic disk, or an optical disc.

The foregoing descriptions are merely alternative embodiments of this disclosure, but are not intended to limit this disclosure. Any modification, equivalent replacement, or improvement made without departing from the spirit and principle of this disclosure should fall within the protection scope of this disclosure.

1. A multicast data sending method implemented by a forwarding device of a plurality of forwarding devices, wherein the method comprises:
receiving multicast data from a control device;
obtaining multicast-broadcast single-frequency network (MBSFN) information, wherein the MBSFN information indicates a first data sending manner, a first channel, and a first time point that are used by a plurality of forwarding devices to forward multicast data; and
forwarding the multicast data to at least one station device in the first data sending manner, on the first channel, and at the first time point.

2. The multicast data sending method of claim 1, wherein the MBSFN information instructs the forwarding devices to send a wake-up data packet (WUP) to a station device of the at least one station device and indicate a second data sending manner, a second channel, and a second time point for the WUP, and wherein after obtaining the MBSFN information, the multicast data sending method further comprises:
sending the WUP to the at least one station device in the second data sending manner, on the second channel, and at the second time point; and
sending the multicast data to the at least one station device on the first channel and at the first time point.

3. The multicast data sending method of claim 1, wherein the MBSFN information comprises first channel information, first time information, and the first data sending manner, and wherein the first data sending manner comprises a physical layer packet format, a transmitter address (TA), a receiver address (RA), bandwidth, a guard interval (GI), a scrambler seed, a space-time block coding (STBC) identifier, or a dual carrier modulation (DCM) identifier, wherein the first channel information indicates the first channel, wherein the first time information indicates the first time point, wherein the physical layer packet format indicates a same physical layer packet format to send the multicast data, wherein the TA indicates a same TA to send the multicast data, wherein the RA indicates a same RA to send the multicast data, wherein the bandwidth indicates a same bandwidth to send the multicast data, wherein the GI indicates a same GI to send the multicast data, wherein the scrambler seed indicates a same scrambler seed to send the multicast data, wherein the STBC identifier indicates whether the multicast data is sent in an STBC manner, and wherein the DCM identifier indicates whether the multicast data is sent in a DCM manner.

4. The multicast data sending method according to claim 1, wherein before obtaining MBSFN information, the multicast data sending method further comprises:
receiving device information of a first station device the at least one station device that is coupled to the forwarding device, wherein the device information comprises at least one of a supported wireless local area network (WLAN) protocol, a first indicator that indicates whether STBC is supported, and a second indicator that indicates whether DCM is supported, and wherein the device information indicates a data sending manner that is supported by the first station device; and
sending device statistical information to the control device, wherein the device statistical information indicates either:
at least one of whether the first station device that is coupled to the forwarding device supports each WLAN protocol, whether the first station device that is coupled to the forwarding device does not support the STBC, or whether the first station device that is coupled to the forwarding device does not support the DCM; or
at least one of whether the first station device that is coupled to the forwarding device is in a first quantity of station devices that supports each WLAN protocol, whether the first station device that is coupled to the forwarding device is in a second quantity of station devices that do not support the STBC, or whether the first station device that is coupled to the forwarding device is in a third quantity of station devices that do not support the DCM.

5. The multicast data sending method of claim 1, wherein obtaining the MBSFN information comprises:
parsing the multicast data to obtain the MBSFN information;
receiving a beacon frame from the control device and parsing the beacon frame to obtain the MBSFN information;
receiving the MBSFN information from the control device after sending device statistical information to the control device, wherein the MBSFN information is based on the device statistical information;
receiving connection information from the control device and parsing the connection information to obtain the MBSFN information, wherein the connection information instructs the forwarding device to establish a connection to the control device; or
obtaining prestored default MBSFN information.

6. The multicast data sending method of claim 1, wherein the MBSFN information comprises first time information, wherein the first time information indicates the first time point, and wherein after obtaining the MBSFN information, the multicast data sending method further comprises:
obtaining a specified time interval that is part of the first time information, and using a first time point at an end of the specified time interval starting from a second time point at which the multicast data is received as the first time point; or
obtaining a specified time interval that is part of the first time information, receiving a synchronization frame from the control device and using a third time point at the end of the specified time interval starting from a fourth time point at which the synchronization frame is received as the first time point; or
obtaining the first time point that is part of the first time information.

7. The multicast data sending method of claim 1, wherein after obtaining the MBSFN information, the method further comprises:
sending the multicast data to the at least one station device in the first data sending manner on the first channel and at the first time point when the first channel is in an idle state.

8. The multicast data sending method of claim 1, wherein:
the control device is an access point (AP) and the forwarding devices are a plurality of relays that are coupled to the AP;
the control device is a specified AP in a first plurality of APs and the forwarding devices are a second plurality of APs other than the specified AP in the first APs; or
the control device is an access controller (AC) and the forwarding devices are a third plurality of APs that are coupled to the AC.

9. A multicast data sending method implemented by a control device, wherein the multicast data sending method comprises:
determining multicast-broadcast single-frequency network (MBSFN) information, wherein the MBSFN information indicates a first data sending manner, a first channel, and a first time point that are used by a plurality of forwarding devices to forward multicast data; and
sending the MBSFN information and the multicast data to a plurality of forwarding devices to prompt each of the forwarding devices to send the multicast data to at least one station device in the first data sending manner on the first channel and at the first time point.

10. The multicast data sending method of claim 9, wherein the MBSFN information comprises first channel information, first time information, and the first data sending manner, wherein the first data sending manner comprises a physical layer packet format, a transmitter address (TA), a receiver address (RA), bandwidth, a guard interval (GI), a scrambler seed, a space-time block coding (STBC) identifier, a dual carrier modulation (DCM) identifier; wherein the MBSFN information is further used to instruct the forwarding devices to send a wake-up data packet (WUP) to a station device and indicate a second data sending manner, a second channel, and a second time point for the WUP, wherein the first channel information indicates the first channel, wherein the first time information indicates the first time point, wherein the physical layer packet format indicates a same physical layer packet format in the multicast data, wherein the TA indicates a same TA in the multicast data, wherein the RA is indicates a same RA in the multicast data, wherein the bandwidth indicates a same bandwidth in the multicast data, wherein the GI indicates a same GI in the multicast data, wherein the scrambler seed indicates a same scrambler seed in the multicast data, wherein the STBC identifier indicates whether the multicast data is received in an STBC manner, and wherein the DCM identifier indicates whether the multicast data is received in a DCM manner.

11. The multicast data sending method of claim 9, wherein before determining the MBSFN information, the multicast data sending method further comprises:
(1) receiving device statistical information from each of the forwarding devices, wherein the device statistical information indicates either:
at least one of whether a first station device that is coupled to a related forwarding device supports each WLAN protocol, whether the first station device that is coupled to the related forwarding device does not support a space-time block coding (STBC), or whether the first station device that is coupled to the related forwarding device does not support a dual carrier modulation (DCM); or
at least one of whether the first station device that is coupled to the related forwarding device is in a first quantity of station devices that supports each WLAN protocol, whether the first station device that is coupled to the related forwarding device is in a second quantity of station devices that do not support the STBC, and whether the first station device that is coupled to the related forwarding device is in a third quantity of station devices that do not support the DCM;
determining, based on the device statistical information from each of the forwarding devices, a data sending manner that is supported by at least one station device that is connected to the forwarding devices; and
determining the MBSFN information based on the data sending manner that is supported by all station devices that are coupled to the forwarding devices; or
(2) determining the MBSFN information based on a data sending manner that is supported by more than a specified quantity of station devices in the station devices that are coupled to the forwarding devices.

12. The multicast data sending method of claim 9, wherein sending the MBSFN information and the multicast data to the forwarding devices comprises:
adding the MBSFN information to the multicast data and sending the multicast data to the forwarding devices; or
adding the MBSFN information to a beacon frame and sending the beacon frame and the multicast data to the forwarding devices; or
adding the MBSFN information to connection information and sending the connection information and the multicast data to the forwarding devices, wherein the connection information instructs each of the forwarding devices to establish a connection to the control device.

13. The multicast data sending method of claim 9, further comprising:
the control device is an access point (AP), and the forwarding devices are a plurality of relays that are coupled to the AP; or
the control device is a specified AP in a first plurality of APs and the forwarding devices are a second plurality of APs other than the specified AP in the first APs; or
the control device is an access controller (ACA) and the forwarding devices are a third plurality of APs that are coupled to the AC.

14. A multicast data sending apparatus, applied to a forwarding device, wherein the multicast data sending apparatus comprises:
a receiver configured to obtain multicast-broadcast single-frequency network (MBSFN) information, wherein the MBSFN information indicates a first data sending manner, a first channel, and a first time point that are used by a plurality of forwarding devices to send multicast data, and wherein the multicast data is received from a control device; and
a transmitter coupled to the receiver and configured to forward the multicast data to at least one station device in the first data sending manner on the first channel at the first time point.

15. The multicast data sending apparatus of claim 14, wherein the multicast data sending apparatus uses the MBSFN information to instruct the forwarding devices to send a wake-up data packet (WUP) to a station device of the at least one station device and indicate a second data sending manner, a second channel, and a second time point for the WUP, and wherein the transmitter is further configured to:
send the WUP to the at least one station device in the second data sending manner on the second channel and at the second time point; and
send the multicast data to the at least one station device on the first channel at the first time point.

16. The multicast data sending apparatus of claim 14, wherein the MBSFN information comprises first channel information, first time information, and the first data sending manner, and wherein the first data sending manner comprises a physical layer packet format, a transmitter address (TA), a receiver address (RA), bandwidth, a guard interval (GI), a scrambler seed, a space-time block coding STBC identifier, or a dual carrier modulation (DCM) identifier; wherein the first channel information indicates the first channel, wherein the first time information indicates the first time point, wherein the physical layer packet format indicates a same physical layer packet format to send the multicast data, wherein the TA indicates a same TA that is used to send the multicast data, wherein the RA indicates a same RA to send the multicast data, wherein the bandwidth indicates a same bandwidth to send the multicast data, wherein the GI indicates a same GI to send the multicast data, wherein the scrambler seed indicates a same scrambler seed to send the multicast data, wherein the STBC identifier indicates whether the multicast data is sent in an STBC manner, and wherein the DCM identifier indicates whether the multicast data is sent in a DCM manner.

17. The multicast data sending apparatus of claim 14, wherein the receiver is further configured to receive device information of a first station device of the at least one station device that is coupled to the forwarding device, wherein the device information comprises at least one of a supported wireless local area network (WLAN) protocol, a first indicator that indicates whether STBC is supported, and a second indicator that indicates whether DCM is supported, and wherein the device information indicates a data sending manner that is supported by the first station device, and wherein the transmitter is further configured to send device statistical information to the control device, wherein the device statistical information indicates either:
at least one of whether the first station device that is coupled to the forwarding device supports each WLAN protocol, whether the first station device that is coupled to the forwarding device does not support the STBC, or whether the first station device that is coupled to the forwarding device does not support the DCM; or
at least one of whether the first station device that is coupled to the forwarding device is in a first quantity of station devices that supports each WLAN protocol, whether the first station device that is coupled to the forwarding device is in a second quantity of station devices that do not support the STBC, or whether the first station device that is coupled to the forwarding device is in a third quantity of station devices that do not support the DCM.

18. The multicast data sending apparatus of claim 14, wherein the receiver is further configured to:
parse the multicast data to obtain the MBSFN information that is part of the multicast data; or
receive a beacon frame from the control device and parse the beacon frame to obtain the MBSFN information that is part of the beacon frame; or
receive the MBSFN information from the control device after sending device statistical information to the control device, wherein the MBSFN information is based on the device statistical information; or
receive connection information from the control device and parse the connection information to obtain the MBSFN information, wherein the connection information instructs the forwarding device to establish a connection to the control device; or
obtain prestored default MBSFN information.

19. The multicast data sending apparatus of claim 14, wherein the MBSFN information comprises first time information, wherein the first time information indicates the first time point, and wherein the receiver is further configured to:
obtain a specified time interval that is part of the first time information and use a first time point at an end of the specified time interval starting from a second time point at which the multicast data is received as the first time point; or
obtain a specified time interval that is part of the first time information, receive a synchronization frame from the control device and use a third time point at the end of the specified time interval starting from a fourth time point at which the synchronization frame is received as the first time point; or
obtain the first time point that is part of the first time information.

20. The multicast data sending apparatus of claim 14, wherein the transmitter is further configured to send the multicast data to the at least one station device in the first data sending manner on the first channel and at the first time point when the first channel is in an idle state.

21. The multicast data sending apparatus of claim 14, wherein:
the control device is an access point (AP), and the forwarding devices are a plurality of relays that are coupled to the AP; or
the control device is a specified AP in a first plurality of APs, and the forwarding devices are a second plurality of APs other than the specified AP in the APs; or
the control device is an access controller (AC) and the forwarding devices are a third plurality of APs that are coupled to the AC.

22. A multicast data sending apparatus applied to a control device, wherein the multicast data sending apparatus comprises:
a processor configured to determine multicast-broadcast single-frequency network (MBSFN) information, wherein the MBSFN information indicates a first data sending manner, a first channel, and first time point that are used by a plurality of forwarding devices to send multicast data; and
a transmitter coupled to the processor and configured to send the MBSFN information and the multicast data to the forwarding devices to prompt each of the forwarding devices to send the multicast data to at least one station device in the first data sending manner on the first channel and at the first time point.

23. The multicast data sending apparatus of claim 22, wherein the MBSFN information comprises first channel information, first time information, and the first data sending manner, wherein the first data sending manner comprises a physical layer packet format, a transmitter address (TA), a receiver address (RA), bandwidth, a guard interval (GI), a scrambler seed, a space-time block coding (STBC) identifier, or a dual carrier modulation (DCM) identifier, wherein the MBSFN information is further used to instruct the forwarding devices to send a wake-up data packet (WUP) to a station device and indicate a second data sending manner, a second channel, and a second time point for the WUP, wherein the first channel information indicates the first channel, wherein the first time information indicates the first time point, wherein the physical layer packet format indicates a same physical layer packet format in the multicast data, wherein the TA indicates a same TA in the multicast data, wherein the RA in the multicast data, wherein the bandwidth is indicates a same bandwidth in the multicast data, wherein the GI indicates a same GI in the multicast data, wherein the scrambler seed indicates a same scrambler seed in the multicast data, wherein the STBC identifier indicates whether the multicast data is received in an STBC manner, and wherein the DCM identifier indicates whether the multicast data is received in a DCM manner.

24. The multicast data sending apparatus of claim 22, wherein the multicast data sending apparatus further comprises a receiver configured to:
(1) receive device statistical information from each of the forwarding devices, wherein the device statistical information indicates either:
at least one of whether a first station device that is coupled to a related forwarding device supports each WLAN protocol, whether the first station device that is coupled to the related forwarding device does not support a space-time block coding (STBC), whether the first station device that is coupled to the related forwarding device does not support a dual carrier modulation (DCM); or
at least one of whether the first station device that is coupled to the related forwarding device is in a first quantity of station devices that supports each WLAN protocol, whether the first station device that is coupled to the related forwarding device is in a second quantity of station devices that do not support the STBC, and whether the first station device that is coupled to the related forwarding device is in a third quantity of station devices that do not support the DCM, and wherein the processor is further configured to:
determine, based on the device statistical information from each of the forwarding devices, a data sending manner that is supported by all station devices that are coupled to the forwarding devices; and
determine the MBSFN information based on the data sending manner that is supported by all of the station devices that are coupled to the forwarding devices; or
(2) determine the MBSFN information based on a data sending manner that is supported by more than a specified quantity of station devices in the station devices that are coupled to the forwarding devices.

25. The multicast data sending apparatus of claim 22, wherein the transmitter is further configured to:
add the MBSFN information to the multicast data and send the multicast data to the forwarding devices; or
add the MBSFN information to a beacon frame and send the beacon frame and the multicast data to the forwarding devices; or
add the MBSFN information to connection information and send the connection information and the multicast data to the forwarding devices, wherein the connection information instructs each of the forwarding devices to establish a connection to the control device.

26. The multicast data sending apparatus of claim 22, wherein:
the control device is an access point (AP) and the forwarding devices are a plurality of that are coupled to the AP; or
the control device is a specified AP in a first plurality of APs and the forwarding devices are a second plurality of APs other than the specified AP in the first APs; or
the control device is an access controller (AC) and the forwarding devices are a third plurality of APs that are coupled to the AC.
